(19) United States
(12) Patent Application Publication
(10) Pub. No.: US 2024/0243289 A1
(43) Pub. Date: Jul. 18, 2024

(54) SLURRY COMPOSITIONS INCLUDING POLYMERS HAVING SILICON-CONTAINING FUNCTIONAL GROUPS FOR LITHIUM ION ELECTRICAL STORAGE DEVICES

(71) Applicant: PPG Industries Ohio, Inc., Cleveland, OH (US)

(72) Inventors: Na Zhang, Allison Park, PA (US); Qi Zheng, Allison Park, PA (US); Bryann Ashleigh Morgan, Pittsburgh, PA (US); Samuel Logan Esarey, Allison Park, PA (US)

(73) Assignee: PPG Industries Ohio, Inc., Cleveland, OH (US)

(21) Appl. No.: 18/560,196

(22) PCT Filed: Mar. 11, 2022
(86) PCT No.: PCT/US2022/019935

§ 371 Date: Nov. 10, 2023

Related U.S. Application Data
(60) Provisional application No. 63/187,605, filed on May 12, 2021.

(51) Int. Cl. H01M 4/62

(52) U.S. Cl. CPC H01M 4/623

(57) ABSTRACT

The present disclosure provides a binder comprising a fluoropolymer; an addition polymer comprising a silicon-containing functional group comprising at least one alkoxy substituent; and a liquid medium. The disclose also provides a slurry composition comprising the binder and an electrochemically active material and/or an electrically conductive agent. Also described herein are electrodes and electrical storage devices.

### NOTICE OF GOVERNMENT SUPPORT

This disclosure was made with Government support under Government Contract No. DE-EE0006250 awarded by the Department of Energy. The United States Government has certain rights in this disclosure.

### FIELD

The disclosure relates to binder composition and slurry compositions that could be used in manufacturing electrodes for use in electrical storage devices, such as batteries.

### BACKGROUND

There is a trend in the electronics industry to produce smaller devices, powered by smaller and lighter electrical storage devices, such as batteries. Electrical storage devices with a negative electrode, such as those including carbonaceous materials as an electrochemically active material, and a positive electrode, such as those including lithium metal oxides as an electrochemically active material, can provide relatively high power and low weight. Fluoropolymers such as polyvinylidene fluoride (PVDF), because of their excellent electrochemical resistance, have been found to be useful binders for forming electrodes to be used in electrical storage devices. Typically, the PVDF fluoropolymer is dissolved in an organic solvent and the electrode material is combined with the solution to form a slurry that is applied to a metal foil or mesh to form the electrode. The role of the organic solvent is to dissolve the fluoropolymer in order to provide good adhesion between the electrode material particles and the metal foil or mesh upon evaporation of the organic solvent. Currently, the organic solvent of choice is N-methyl-2-pyrrolidone (NMP). PVDF binders dissolved in NMP provide superior adhesion and an interconnectivity of all the active ingredients in the electrode composition. The bound ingredients are able to tolerate large volume expansion and contraction during charge and discharge cycles without losing interconnectivity within the electrodes. Interconnectivity of the active ingredients in an electrode is extremely important in battery performance, especially during charging and discharging cycles, as electrons must move through the electrode, and lithium ion mobility requires interconnectivity within the electrode between particles. Unfortunately, NMP is a toxic material and presents health and environmental issues.

Alternative technologies to NMP have been developed. However, for the alternative technologies to be useful they must be compatible with current manufacturing practices and provide desired properties of the intermediate and final products. Some common criteria include a viscosity of the slurry appropriate to facilitate good application properties, sufficient interconnectivity within the electrode, sufficient adhesion to the underlying substrate, and sufficient durability of the binder for the resulting electrode coating to the electrolyte in the battery.

### BRIEF DESCRIPTION OF THE DRAWING

FIG. 1 is a graph showing the cycling performance of electrodes from Example 1 below tested in cells at 0.1 C for 3 cycles, 0.3 C, 0.6 C, 1.0 C and 1.5 C for 5 cycles, respectively, and 1.0 C for long term cycling.

### SUMMARY

The present disclosure provides a slurry composition comprising an electrochemically active material and/or an electrically conductive agent; a fluoropolymer; an addition polymer comprising a silicon-containing functional group comprising at least one alkoxy substituent; and a liquid medium.

The present disclosure also provides an electrode comprising a current collector and a film on the surface of the current collector, the film comprising an electrochemically active material and/or an electrically conductive agent; a fluoropolymer; and an addition polymer comprising a silicon-containing functional group comprising at least one alkoxy substituent.

The present disclosure further provides an electrical storage device comprising: (a) comprising a current collector and a film on the surface of the current collector, the film comprising an electrochemically active material and/or an electrically conductive agent; a fluoropolymer; and an addition polymer comprising a silicon-containing functional group comprising at least one alkoxy substituent; (b) a counter electrode; and (c) an electrolyte.

The present disclosure also provides a binder composition comprising a fluoropolymer; and an addition polymer comprising a silicon-containing functional group comprising at least one alkoxy substituent.

### DETAILED DESCRIPTION

The present disclosure is directed to a binder composition comprising a fluoropolymer and an addition polymer comprising a silicon-containing functional group comprising at least one alkoxy substituent.

The binder composition may be used in a slurry composition, and the present disclosure is also directed to a slurry composition comprising a fluoropolymer; an addition polymer comprising a silicon-containing functional group comprising at least one alkoxy substituent; an electrochemically active material and/or an electrically conductive agent; and a liquid medium.

According to the present disclosure, the binder composition and/or slurry composition comprises a fluoropolymer. The fluoropolymer is part of the binder of the slurry composition. The fluoropolymer may comprise a (co)polymer comprising the residue of vinylidene fluoride. A non-limiting example of a (co)polymer comprising the residue of vinylidene fluoride is a polyvinylidene fluoride polymer (PVDF). As used herein, the “polyvinylidene fluoride polymer” includes homopolymers, copolymers, such as binary copolymers, and terpolymers, including high molecular weight homopolymers, copolymers, and terpolymers. Such (co)polymers include those containing at least 50 mole percent, such as at least 75 mole %, and at least 80 mole %, and at least 85 mole % of the residue of vinylidene fluoride (also known as vinylidene difluoride). The vinylidene fluoride monomer may be copolymerized with at least one comonomer comprising, consisting essentially of, or consisting of vinyl halide monomers (such as trifluoroethylene, chlorotrifluoroethylene, hexafluoropropene, vinyl chloride, vinyl fluoride, pentafluoropropene, tetrafluoropropene, and the like), vinyl fluoro ethers having the formula F₂C═CF(OR^{f}) where R^{F} is a fluorinated alkyl chain (such as perfluoromethyl vinyl ether, perfluoropropyl vinyl ether, and the like), (meth)acrylic-based monomers (including any of those described herein), and any other monomer that would readily copolymerize with vinylidene fluoride in order to produce the fluoropolymer of the present disclosure. The fluoropolymer may also comprise a PVDF homopolymer.

The polyvinylidene fluoride may comprise a polyvinylidene fluoride copolymer comprising constitutional units comprising the residue of vinylidene fluoride and at least one of (i) a (meth)acrylic acid; and/or (ii) a hydroxyalkyl (meth)acrylate. The (meth)acrylic acid may comprise acrylic acid, methacrylic acid, or combinations thereof. The hydroxyalkyl (meth)acrylate may comprise a C₁ to C₅ hydroxyalkyl (meth)acrylate, such as, for example, hydroxyethyl (meth)acrylate, 2-hydroxypropyl (meth)acrylate, 2-hydroxybutyl (meth)acrylate, or combinations thereof. A commercially available example of such a polyvinylidene fluoride copolymer includes SOLEF 5130, available from Solvay.

The fluoropolymer may comprise a high molecular weight PVDF having a weight average molecular weight of at least 50,000 g/mol, such as at least 100,000 g/mol, and may range from 50,000 g/mol to 1,500,000 g/mol, such as 100,000 g/mol to 1,000,000 g/mol. PVDF is commercially available, e.g., from Arkema under the trademark KYNAR from Solvay under the trademark HYLAR, and from Inner Mongolia 3F Wanhao Fluorochemical Co., Ltd.

The fluoropolymer used in preparing the binder may comprise a nanoparticle. As used herein, the term “nanoparticle” refers to particles having a particle size of less than 1,000 nm. The fluoropolymer may have a particle size of at least 50 nm, such as at least 100 nm, such as at least 250 nm, such as at least 300 nm, and may be no more than 900 nm, such as no more than 600 nm, such as no more than 450 nm, such as no more than 400 nm, such as no more than 300 nm, such as no more than 200 nm. The fluoropolymer nanoparticles may have a particle size of 50 nm to 900 nm, such as 100 nm to 600 nm, such as 250 nm to 450 nm, such as 300 nm to 400 nm, such as 100 nm to 400 nm, such as 100 nm to 300 nm, such as 100 nm to 200 nm. As used herein, the term “particle size” refers to average diameter of the fluoropolymer particles. The particle size referred to in the present disclosure was determined by the following procedure: A sample was prepared by dispersing the fluoropolymer onto a segment of carbon tape that was attached to an aluminum scanning electron microscope (SEM) stub. Excess particles were blown off the carbon tape with compressed air. The sample was then sputter coated with Au/Pd for 20 seconds and was then analyzed in a Quanta 250 FEG SEM (field emission gun scanning electron microscope) under high vacuum. The accelerating voltage was set to 20.00 kV and the spot size was set to 3.0. Images were collected from three different areas on the prepared sample, and ImageJ software was used to measure the diameter of 10 fluoropolymer particles from each area for a total of 30 particle size measurements that were averaged together to determine the average particle size.

The fluoropolymer may be dispersed or solubilized in the liquid medium.

The fluoropolymer may be present in in the binder in amounts of at least 20% by weight, such as at least 30% by weight, such as at least 40% by weight, such as at least 50% by weight, such as at least 60% by weight, such as at least 70% by weight, such as at least 80% by weight, such as at least 85% by weight, such as at least 90% by weight, such as at least 95% by weight, such as at least 98% by weight, based on the total weight of the binder solids. The fluoropolymer may be present in in the binder in amounts of no more than 99.9% by weight, such as no more than 99% by weight, such as no more than 98% by weight, such as no more than 96% by weight, such as no more than 95% by weight, such as no more than 90% by weight, such as no more than 85% by weight, such as no more than 80% by weight, based on the total weight of the binder solids. The fluoropolymer may be present in in the binder in amounts of 20% to 99.9% by weight, 20% to 99% by weight, such as 20% to 98% by weight, such as 20% to 96% by weight, such as 20% to 95% by weight, such as 20% to 90% by weight, such as 20% to 85% by weight, such as 20% to 80% by weight, such as 30% to 99.9% by weight, such as 30% to 99% by weight, such as 30% to 98% by weight, such as 30% to 96% by weight, such as 30% to 95% by weight, such as 30% to 90% by weight, such as 30% to 85% by weight, such as 30% to 80% by weight, such as 40% to 99.9% by weight, such as 40% to 99% by weight, such as 40% to 98% by weight, such as 40% to 96% by weight, such as 40% to 95% by weight, such as 40% to 90% by weight, such as 40% to 85% by weight, such as 40% to 80% by weight, such as 50% to 99.9% by weight, such as 50% to 99% by weight, such as 50% to 98% by weight, such as 50% to 96% by weight, such as 50% to 95% by weight, such as 50% to 90% by weight, such as 50% to 85% by weight, such as 50% to 80% by weight, such as 60% to 99.9% by weight, such as 60% to 99% by weight, such as 60% to 98% by weight, such as 60% to 96% by weight, such as 60% to 95% by weight, such as 60% to 90% by weight, such as 60% to 85% by weight, such as 60% to 80% by weight, such as 70% to 99.9% by weight, such as 70% to 99% by weight, such as 70% to 98% by weight, such as 70% to 96% by weight, such as 70% to 95% by weight, such as 70% to 90% by weight, such as 70% to 85% by weight, such as 70% to 80% by weight, such as 80% to 99.9% by weight, such as 80% to 99% by weight, such as 80% to 98% by weight, such as 80% to 96% by weight, such as 80% to 95% by weight, such as 80% to 90% by weight, such as 80% to 85% by weight, such as 85% to 99.9% by weight, such as 85% to 99% by weight, such as 85% to 98% by weight, such as 85% to 96% by weight, such as 85% to 95% by weight, such as 85% to 90% by weight, such as 90% to 99.9% by weight, such as 90% to 99% by weight, such as 90% to 98% by weight, such as 90% to 96% by weight, such as 95% to 99.9% by weight, such as 95% to 99% by weight, such as 95% to 98% by weight, such as 95% to 96% by weight, such as 98% to 99.9% by weight, such as 98% to 99% by weight, based on the total weight of the binder solids.

The fluoropolymer may be present in the binder composition in an amount of at least 1% by weight, such as at least 5% by weight, such as at least 10% by weight, such as least 20% by weight, such as at least 25% by weight, such as at least 30% by weight, such as at least 40% by weight, based on the total weight of the binder composition. The fluoropolymer may be present in the binder composition in an amount of no more than 50% by weight, such as no more than 40% by weight, such as no more than 30% by weight, such as no more than 25% by weight, such as no more than 20% by weight, such as no more than 10% by weight, based on the total weight of the binder composition. The fluoropolymer may be present in the binder composition in an amount of 1% to 50% by weight, such as 1% to 40% by weight, such as 1% to 30% by weight, such as 1% to 25% by weight, such as 1% to 20% by weight, such as 1% to 10% by weight, such as 5% to 50% by weight, such as 5% to 40% by weight, such as 5% to 30% by weight, such as 5% to 25% by weight, such as 5% to 20% by weight, such as 5% to 10% by weight, such as 10% to 40% by weight, such as 10% to 30% by weight, such as 10% to 25% by weight, such as 10% to 20% by weight, such as 20% to 50% by weight, such as 20% to 40% by weight, such as 20% to 30% by weight, such as 20% to 25% by weight, such as 25% to 50% by weight, such as 25% to 40% by weight, such as 25% to 30% by weight, such as 30% to 50% by weight, such as 30% to 40% by weight, such as 40% to 50% by weight, based on the total weight of the binder composition.

The fluoropolymer may be present in the slurry composition in an amount of at least 0.1% by weight, such as at least 0.5% by weight, such as at least 1% by weight, such as at least 1.3% by weight, such as at least 1.9% by weight, based on the total solids weight of the slurry composition. The fluoropolymer may be present in the slurry composition in an amount of no more than 10% by weight, such as no more than 6% by weight, such as no more than 4.5% by weight, such as no more than 2.9% by weight, such as no more than 2% by weight, based on the total solids weight of the slurry composition. The fluoropolymer may be present in the slurry composition in an amount of 0.1% to 10% by weight, such as 0.1% to 6% by weight, such as 0.1% to 4.5% by weight, such as 0.1% to 2.9% by weight, such as 0.1% to 2% by weight, such as 0.5% to 10% by weight, such as 0.5% to 6% by weight, such as 0.5% to 4.5% by weight, such as 0.5% to 2.9% by weight, such as 0.5% to 2% by weight, such as 1% to 10% by weight, such as 1% to 6% by weight, such as 1% to 4.5% by weight, such as 1% to 2.9% by weight, such as 1% to 2% by weight, such as 1.3% to 10% by weight, such as 1.3% to 6% by weight, such as 1.3% to 4.5% by weight, such as 1.3% to 2.9% by weight, such as 1.3% to 2% by weight, such as 1.9% to 10% by weight, such as 1.9% to 6% by weight, such as 1.9% to 4.5% by weight, such as 1.9% to 2.9% by weight, such as 1.9% to 2% by weight, based on the total solids weight of the slurry composition.

The binder composition and/or slurry composition further comprises an addition polymer comprising a silicon-containing functional group comprising at least one alkoxy substituent. The addition polymer may be in the form of a block polymer, a random polymer, or a gradient polymer.

As used herein, a “silicon-containing functional group” refers to an organosilicon group bound to the polymer backbone that comprises organic substituents. The silicon-containing functional group comprises at least one alkoxy substituent and may be represented by the general formula —SiR¹ₐX₃₋ₐ wherein R¹ represents a substituted or unsubstituted hydrocarbon group with 1 to 20 carbon atoms, each X independently represents a hydroxyl group or a hydrolysable group wherein at least one X is an alkoxy group, and a is 0, 1, or 2. Accordingly, the silicon-containing functional group may comprise one alkoxy substituent, two alkoxy substituents, three alkoxy substituents, or any combination thereof, and the addition polymer may comprise an ethylenically unsaturated monomer comprising a silicon-containing functional group comprising one alkoxy substituent, a silicon-containing functional group comprising two alkoxy substituents, a silicon-containing functional group comprising three alkoxy substituents, or any combination thereof.

The addition polymer may comprise constitutional units comprising the residue of one or more ethylenically unsaturated monomers, including the ethylenically unsaturated monomer comprising a silicon-containing functional group comprising at least one alkoxy substituent. The addition polymer may be prepared by polymerizing a reaction mixture of alpha, beta-ethylenically unsaturated monomers that comprise one or more ethylenically unsaturated monomers.

The silicon-containing functional group may be included in the addition polymer as an ethylenically unsaturated monomer comprising a silicon-containing functional group included during polymerization of the addition polymer. The addition polymer may comprise constitutional units comprising the residue of an ethylenically unsaturated monomer comprising a silicon-containing functional group comprising at least one alkoxy substituent. The addition polymer may comprise constitutional units comprising the residue of an ethylenically unsaturated monomer comprising a silicon-containing functional group comprising at least one alkoxy substituent in an amount of at least 0.5% by weight, such as at least 1% by weight, such as at least 5% by weight, such as at least 10% by weight, such as at least 20% by weight, such as at least 30% by weight, such as at least 40% by weight, such as at least 50% by weight, such as at least 60% by weight, such as at least 70% by weight, such as at least 80% by weight, such as at least 90% by weight, based on the total weight of the addition polymer. The addition polymer may comprise constitutional units comprising the residue of an ethylenically unsaturated monomer comprising a silicon-containing functional group comprising at least one alkoxy substituent in an amount of 100% by weight, such as no more than 90% by weight, such as no more than 80% by weight, such as no more than 70% by weight, such as no more than 60% by weight, such as no more than 50% by weight, such as no more than 40% by weight, such as no more than 30% by weight, such as no more than 20% by weight, such as no more than 10% by weight, such as no more than 5% by weight, based on the total weight of the addition polymer. The addition polymer may comprise constitutional units comprising the residue of an ethylenically unsaturated monomer comprising a silicon-containing functional group comprising at least one alkoxy substituent in an amount of 0.5% to 100% by weight, such as 1% to 100% by weight, such as 5% to 100% by weight, such as 10% to 100% by weight, such as 20% to 100% by weight, such as 30% to 100% by weight, such as 40% to 100% by weight, such as 50% to 100% by weight, such as 60% to 100% by weight, such as 70% to 100% by weight, such as 80% to 100% by weight, such as 90% to 100% by weight, such as 0.5% to 90% by weight, such as 1% to 90% by weight, such as 5% to 90% by weight, such as 10% to 90% by weight, such as 20% to 90% by weight, such as 30% to 90% by weight, such as 40% to 90% by weight, such as 50% to 90% by weight, such as 60% to 90% by weight, such as 70% to 90% by weight, such as 80% to 90% by weight, such as 0.5% to 80% by weight, such as 1% to 80% by weight, such as 5% to 80% by weight, such as 10% to 80% by weight, such as 20% to 80% by weight, such as 30% to 80% by weight, such as 40% to 80% by weight, such as 50% to 80% by weight, such as 60% to 80% by weight, such as 70% to 80% by weight, such as 0.5% to 70% by weight, such as 1% to 70% by weight, such as 5% to 70% by weight, such as 10% to 70% by weight, such as 20% to 70% by weight, such as 30% to 70% by weight, such as 40% to 70% by weight, such as 50% to 70% by weight, such as 60% to 70% by weight, such as 0.5% to 60% by weight, such as 1% to 60% by weight, such as 5% to 60% by weight, such as 10% to 60% by weight, such as 20% to 60% by weight, such as 30% to 60% by weight, such as 40% to 60% by weight, such as 50% to 60% by weight, such as 0.5% to 50% by weight, such as 1% to 50% by weight, such as 5% to 50% by weight, such as 10% to 50% by weight, such as 20% to 50% by weight, such as 30% to 50% by weight, such as 40% to 50% by weight, such as 0.5% to 40% by weight, such as 1% to 40% by weight, such as 5% to 40% by weight, such as 10% to 40% by weight, such as 20% to 40% by weight, such as 30% to 40% by weight, such as 0.5% to 30% by weight, such as 1% to 30% by weight, such as 5% to 30% by weight, such as 10% to 30% by weight, such as 20% to 30% by weight, such as 0.5% to 20% by weight, such as 1% to 20% by weight, such as 5% to 20% by weight, such as 10% to 20% by weight, such as 0.5% to 10% by weight, such as 1% to 10% by weight, such as 5% to 10% by weight, such as 0.5% to 5% by weight, such as 1% to 5% by weight, based on the total weight of the addition polymer. The addition polymer may be derived from a reaction mixture comprising the ethylenically unsaturated monomer comprising a silicon-containing functional group comprising at least one alkoxy substituent in an amount of 0.5% to 100% by weight, such as 1% to 100% by weight, such as 5% to 100% by weight, such as 10% to 100% by weight, such as 20% to 100% by weight, such as 30% to 100% by weight, such as 40% to 100% by weight, such as 50% to 100% by weight, such as 60% to 100% by weight, such as 70% to 100% by weight, such as 80% to 100% by weight, such as 90% to 100% by weight, such as 0.5% to 90% by weight, such as 1% to 90% by weight, such as 5% to 90% by weight, such as 10% to 90% by weight, such as 20% to 90% by weight, such as 30% to 90% by weight, such as 40% to 90% by weight, such as 50% to 90% by weight, such as 60% to 90% by weight, such as 70% to 90% by weight, such as 80% to 90% by weight, such as 0.5% to 80% by weight, such as 1% to 80% by weight, such as 5% to 80% by weight, such as 10% to 80% by weight, such as 20% to 80% by weight, such as 30% to 80% by weight, such as 40% to 80% by weight, such as 50% to 80% by weight, such as 60% to 80% by weight, such as 70% to 80% by weight, such as 0.5% to 70% by weight, such as 1% to 70% by weight, such as 5% to 70% by weight, such as 10% to 70% by weight, such as 20% to 70% by weight, such as 30% to 70% by weight, such as 40% to 70% by weight, such as 50% to 70% by weight, such as 60% to 70% by weight, such as 0.5% to 60% by weight, such as 1% to 60% by weight, such as 5% to 60% by weight, such as 10% to 60% by weight, such as 20% to 60% by weight, such as 30% to 60% by weight, such as 40% to 60% by weight, such as 50% to 60% by weight, such as 0.5% to 50% by weight, such as 1% to 50% by weight, such as 5% to 50% by weight, such as 10% to 50% by weight, such as 20% to 50% by weight, such as 30% to 50% by weight, such as 40% to 50% by weight, such as 0.5% to 40% by weight, such as 1% to 40% by weight, such as 5% to 40% by weight, such as 10% to 40% by weight, such as 20% to 40% by weight, such as 30% to 40% by weight, such as 0.5% to 30% by weight, such as 1% to 30% by weight, such as 5% to 30% by weight, such as 10% to 30% by weight, such as 20% to 30% by weight, such as 0.5% to 20% by weight, such as 1% to 20% by weight, such as 5% to 20% by weight, such as 10% to 20% by weight, such as 0.5% to 10% by weight, such as 1% to 10% by weight, such as 5% to 10% by weight, such as 0.5% to 5% by weight, such as 1% to 5% by weight, based on the total weight of polymerizable monomers used in the reaction mixture.

The addition polymer may have a silicon-containing functional group equivalent weight of such as at least 500 g/eq, such as at least 750 g/eq, such as at least 1,000 g/eq, such as at least 1,200 g/eq, such as at least 1,500 g/eq, such as at least 2,500 g/eq, such as at least 5,000 g/eq. The addition polymer may have a silicon-containing functional group equivalent weight of no more than 50,000 g/eq, such as no more than 25,000 g/eq, such as no more than 15,000 g/eq. such as no more than 10,000 g/eq, such as no more than 5,000 g/eq, such as no more than 2,500 g/eq, such as no more than 2,000 g/eq. The addition polymer may have a silicon-containing functional group equivalent weight of 500 to 50,000 g/eq, such as 500 to 25,000 g/eq, such as 500 to 15,000 g/eq, such as 500 to 10,000 g/eq, such as 500 to 5,000 g/eq, such as 500 to 2,500 g/eq, such as 500 to 2,000 g/eq, such as 750 to 50,000 g/eq, such as 750 to 25,000 g/eq, such as 750 to 15,000 g/eq, such as 750 to 10,000 g/eq, such as 750 to 5,000 g/eq, such as 750 to 2,500 g/eq, such as 750 to 2,000 g/eq, such as 1,000 to 50,000 g/eq, such as 1,000 to 25,000 g/eq, such as 1,000 to 15,000 g/eq, such as 1,000 to 10,000 g/eq, such as 1,000 to 5,000 g/eq, such as 1,000 to 2,500 g/eq. such as 1,000 to 2,000 g/eq. such as 1,200 to 50,000 g/eq, such as 1,200 to 25,000 g/eq, such as 1,200 to 15,000 g/eq, such as 1,200 to 10,000 g/eq, such as 1,200 to 5,000 g/eq. such as 1,200 to 2,500 g/eq, such as 1,200 to 2,000 g/eq, such as 1,500 to 50,000 g/eq, such as 1,500 to 25,000 g/eq, such as 1,500 to 15,000 g/eq, such as 1,500 to 10,000 g/eq, such as 1,500 to 5,000 g/eq, such as 1,500 to 2,500 g/eq, such as 1,500 to 2,000 g/eq, 2,500 to 50,000 g/eq, such as 2,500 to 25,000 g/eq, such as 2,500 to 15,000 g/eq, such as 2,500 to 10,000 g/eq, such as 2,500 to 5,000 g/eq, such as 5,000 to 50,000 g/eq, such as 5,000 to 25,000 g/eq, such as 5,000 to 15,000 g/eq, such as 5,000 to 10,000 g/eq. As used herein, the silicon-containing functional group equivalent weight refers to a theoretical value determined by dividing the total theoretical weight of the addition polymer by the total number of equivalents of silicon-containing groups theoretically present therein.

The addition polymer may have an alkoxy equivalent weight of at least 75 g/eq. such as at least 100 g/eq, such as at least 250 g/eq, such as at least 500 g/eq, such as at least 750 g/eq, such as at least 1,000 g/eq, such as at least 1,200 g/eq, such as at least 1,500 g/eq, such as at least 2,000 g/eq. The addition polymer may have an alkoxy equivalent weight of no more than 15,000 g/eq, such as no more than 10,000 g/eq, such as no more than 7,500 g/eq, such as no more than 5,000 g/eq, such as no more than 2,500 g/eq, such as no more than 2,000 g/eq, such as no more than 1,500 g/eq, such as no more than 1,000 g/eq, such as no more than 750 g/eq, such as no more than 600 g/eq, such as no more than 500 g/eq. The addition polymer may have an alkoxy equivalent weight of 75 to 15,000 g/eq, such as 75 to 10,000 g/eq, such as 75 to 7,500 g/eq, such as 75 to 5,000 g/eq, such as 75 to 2,500 g/eq, such as 75 to 2,000 g/eq, such as 75 to 1,500 g/eq, such as 75 to 1,000 g/eq, such as 75 to 750 g/eq, such as 75 to 600 g/eq, such as 75 to 500 g/eq, such as 100 to 15,000 g/eq, such as 100 to 10,000 g/eq, such as 100 to 7,500 g/eq, such as 100 to 5,000 g/eq, such as 100 to 2,500 g/eq, such as 100 to 2,000 g/eq, such as 100 to 1,500 g/eq, such as 100 to 1,000 g/eq, such as 100 to 750 g/eq, such as 100 to 600 g/eq, such as 100 to 500 g/eq, such as 250 to 15,000 g/eq, such as 250 to 10,000 g/eq, such as 250 to 7,500 g/eq, such as 250 to 5,000 g/eq, such as 250 to 2,500 g/eq, such as 250 to 2,000 g/eq, such as 250 to 1,500 g/eq, such as 250 to 1,000 g/eq, such as 250 to 750 g/eq, such as 250 to 600 g/eq, such as 250 to 500 g/eq, such as 500 to 15,000 g/eq, such as 500 to 10,000 g/eq, such as 500 to 7,500 g/eq, such as 500 to 5,000 g/eq, such as 500 to 2,500 g/eq, such as 500 to 2,000 g/eq, such as 500 to 1,500 g/eq, such as 500 to 1,000 g/eq, such as 500 to 750 g/eq, such as 500 to 600 g/eq, such as 750 to 15,000 g/eq, such as 750 to 10,000 g/eq, such as 750 to 7,500 g/eq, such as 750 to 5,000 g/eq, such as 750 to 2,500 g/eq, such as 750 to 2,000 g/eq, such as 750 to 1,500 g/eq, such as 750 to 1,000 g/eq, such as 1,000 to 15,000 g/eq, such as 1,000 to 10,000 g/eq, such as 1,000 to 7,500 g/eq, such as 1,000 to 5,000 g/eq, such as 1,000 to 2,500 g/eq, such as 1,000 to 2,000 g/eq, such as 1,000 to 1,500 g/eq, such as 1,200 to 15,000 g/eq, such as 1,200 to 10,000 g/eq, such as 1,200 to 7,500 g/eq, such as 1,200 to 5,000 g/eq, such as 1,200 to 2,500 g/eq, such as 1,200 to 2,000 g/eq, such as 1,200 to 1,500 g/eq, such as 1,500 to 15,000 g/eq, such as 1,500 to 10,000 g/eq, such as 1,500 to 7,500 g/eq, such as 1,500 to 5,000 g/eq. such as 1,500 to 2,500 g/eq, such as 1,500 to 2,000 g/eq, such as 2,000 to 15,000 g/eq, such as 2,000 to 10,000 g/eq, such as 2,000 to 7,500 g/eq, such as 2,000 to 5,000 g/eq, such as 2,000 to 2,500 g/eq. As used herein, the alkoxy equivalent weight refers to a theoretical value determined by dividing the total theoretical weight of the addition polymer by the total number of equivalents of alkoxy groups theoretically present therein.

The addition polymer may optionally comprise constitutional units comprising the residue, or be derived from, alkyl esters of (meth)acrylic acid, ethylenically unsaturated monomers comprising one or more active hydrogen groups, ethylenically unsaturated monomers comprising a heterocyclic group, ethylenically unsaturated monomers comprising a silicon-containing functional group, as well as other ethylenically unsaturated monomers, including combinations thereof.

The addition polymer may optionally comprise constitutional units comprising the residue of an alkyl esters of (meth)acrylic acid containing from 1 to 18 carbon atoms in the alkyl group, such as 1 to 10 carbon atoms in the alkyl group. Non-limiting examples of alkyl esters of (meth)acrylic acid containing from 1 to 18 carbon atoms in the alkyl group include methyl (meth)acrylate, ethyl (meth)acrylate, butyl (meth)acrylate, hexyl(meth)acrylate, octyl (meth)acrylate, isodecyl(meth)acrylate, stearyl (meth)acrylate, 2-ethylhexyl (meth)acrylate, decyl(meth)acrylate and dodecyl (meth)acrylate. The constitutional units comprising the residue of the alkyl esters of (meth)acrylic acid containing from 1 to 18 carbon atoms in the alkyl group may comprise at least 30% by weight, such as at least 35% by weight, such as at least 40% by weight, such as at least 45% by weight, such as at least 47.5% by weight, based on the total weight of the addition polymer. The constitutional units comprising the residue of the alkyl esters of (meth)acrylic acid containing from 1 to 18 carbon atoms in the alkyl group may comprise no more than 96%, such as no more than 90%, such as no more than 85%, such as no more than 80%, such as no more than 75%, such as no more than 70%, such as no more than 65%, based on the total weight of the addition polymer. The constitutional units comprising the residue of the alkyl esters of (meth)acrylic acid containing from 1 to 18 carbon atoms in the alkyl group may comprise 30% to 96% by weight, such as 30% to 90% by weight, such as 30% to 85% by weight, such as 30% to 80% by weight, such as 30% to 75% by weight, such as 30% to 70% by weight, such as 30% to 65% by weight, such as 35% to 96% by weight, such as 35% to 90% by weight, such as 35% to 85% by weight, such as 35% to 80% by weight, such as 35% to 75% by weight, such as 35% to 70% by weight, such as 35% to 65% by weight, such as 40% to 96% by weight, such as 40% to 90% by weight, such as 40% to 85% by weight, such as 40% to 80% by weight, such as 40% to 75% by weight, such as 40% to 70% by weight, such as 40% to 65% by weight, such as 45% to 96% by weight, such as 45% to 90% by weight, such as 45% to 85% by weight, such as 45% to 80% by weight, such as 45% to 75% by weight, such as 45% to 70% by weight, such as 45% to 65% by weight, such as 47.5% to 96% by weight, such as 47.5% to 90% by weight, such as 47.5% to 85% by weight, such as 47.5% to 80% by weight, such as 47.5% to 75% by weight, such as 47.5% to 70% by weight, such as 47.5% to 65% by weight, based on the total weight of the addition polymer. The addition polymer may be derived from a reaction mixture comprising the alkyl esters of (meth)acrylic acid containing from 1 to 18 carbon atoms in the alkyl group in an amount of 30% to 96% by weight, such as 30% to 90% by weight, such as 30% to 85% by weight, such as 30% to 80% by weight, such as 30% to 75% by weight, such as 30% to 70% by weight, such as 30% to 65% by weight, such as 35% to 96% by weight, such as 35% to 90% by weight, such as 35% to 85% by weight, such as 35% to 80% by weight, such as 35% to 75% by weight, such as 35% to 70% by weight, such as 35% to 65% by weight, such as 40% to 96% by weight, such as 40% to 90% by weight, such as 40% to 85% by weight, such as 40% to 80% by weight, such as 40% to 75% by weight, such as 40% to 70% by weight, such as 40% to 65% by weight, such as 45% to 96% by weight, such as 45% to 90% by weight, such as 45% to 85% by weight, such as 45% to 80% by weight, such as 45% to 75% by weight, such as 45% to 70% by weight, such as 45% to 65% by weight, such as 47.5% to 96% by weight, such as 47.5% to 90% by weight, such as 47.5% to 85% by weight, such as 47.5% to 80% by weight, such as 47.5% to 75% by weight, such as 47.5% to 70% by weight, such as 47.5% to 65% by weight, based on the total weight of polymerizable monomers used in the reaction mixture.

The addition polymer may optionally comprise constitutional units comprising the residue of a hydroxyalkyl ester. Non-limiting examples of hydroxyalkyl esters include hydroxyethyl (meth)acrylate and hydroxypropyl (meth)acrylate. The constitutional units comprising the residue of the hydroxyalkyl ester may comprise at least 0.5% by weight, such as at least 1% by weight, such as at least 1.5% by weight, based on the total weight of the addition polymer. The constitutional units comprising the residue of the hydroxyalkyl ester may comprise no more than 20% by weight, such as no more than 15% by weight, such as no more than 8% by weight, such as no more than 6% by weight, such as no more than 5% by weight, such as no more than 4% by weight, such as no more than 3% by weight, such as no more than 2% by weight, such as no more than 1.5% by weight, such as no more than 1.0% by weight, based on the total weight of the addition polymer. The constitutional units comprising the residue of the hydroxyalkyl ester may comprise 0.5% to 20% by weight, such as 0.5% to 15% by weight, such as 0.5% to 10% by weight, such as 0.5% to 8% by weight, such as 0.5% to 6% by weight, such as 0.5% by to 5% by weight, such as 0.5% to 4% by weight, such as 0.5% to 3% by weight, such as 0.5% to 2% by weight, such as 0.5% to 1.5% by weight, such as 0.5% to 1.0% by weight, such as 1% to 20% by weight, such as 1% to 15% by weight, such as 1% to 10% by weight, such as 1% to 8% by weight, such as 1% to 6% by weight, such as 1% by to 5% by weight, such as 1% to 4% by weight, such as 1% to 3% by weight, such as 1% to 2% by weight, such as 1% to 1.5% by weight, such as 1.5% to 20% by weight, such as 1.5% to 15% by weight, such as 1.5% to 10% by weight, such as 1.5% to 8% by weight, such as 1.5% to 6% by weight, such as 1.5% by to 5% by weight, such as 1.5% to 4% by weight, such as 1.5% to 3% by weight, such as 1.5% to 2% by weight, based on the total weight of the addition polymer. The addition polymer may be derived from a reaction mixture comprising the hydroxyalkyl ester in an amount of 0.5% to 20% by weight, such as 0.5% to 15% by weight, such as 0.5% to 10% by weight, such as 0.5% to 8% by weight, such as 0.5% to 6% by weight, such as 0.5% by to 5% by weight, such as 0.5% to 4% by weight, such as 0.5% to 3% by weight, such as 0.5% to 2% by weight, such as 0.5% to 1.5% by weight, such as 0.5% to 1.0% by weight, such as 1% to 20% by weight, such as 1% to 15% by weight, such as 1% to 10% by weight, such as 1% to 8% by weight, such as 1% to 6% by weight, such as 1% by to 5% by weight, such as 1% to 4% by weight, such as 1% to 3% by weight, such as 1% to 2% by weight, such as 1% to 1.5% by weight, such as 1.5% to 20% by weight, such as 1.5% to 15% by weight, such as 1.5% to 10% by weight, such as 1.5% to 8% by weight, such as 1.5% to 6% by weight, such as 1.5% by to 5% by weight, such as 1.5% to 4% by weight, such as 1.5% to 3% by weight, such as 1.5% to 2% by weight, based on the total weight of polymerizable monomers used in the reaction mixture. The inclusion of constitutional units comprising the residue of a hydroxyalkyl ester in the addition polymer results in an addition polymer comprising at least one hydroxyl group (although hydroxyl groups may be included by other methods). Hydroxyl groups resulting from inclusion of the hydroxyalkyl esters (or incorporated by other means) may react with a separately added crosslinking agent that comprises functional groups reactive with hydroxyl groups such as, for example, an aminoplast, phenolplast, and polyepoxides, or with N-alkoxymethyl amide groups present in the addition polymer when self-crosslinking monomers that have groups that are reactive with the hydroxyl groups are incorporated into the addition polymer.

The addition polymer may optionally comprise constitutional units comprising the residue of an alpha, beta-ethylenically unsaturated carboxylic acid. Non-limiting examples of alpha, beta-ethylenically unsaturated carboxylic acids include those containing up to 10 carbon atoms such as acrylic acid and methacrylic acid. Non-limiting examples of other unsaturated acids are alpha, beta-ethylenically unsaturated dicarboxylic acids such as maleic acid or its anhydride, fumaric acid and itaconic acid. Also, the half esters of these dicarboxylic acids may be employed. If present, the constitutional units comprising the residue of the alpha, beta-ethylenically unsaturated carboxylic acids may comprise at least 0.5% by weight, such as at least 1% by weight, such as at least 1.5% by weight, based on the total weight of the addition polymer. If present, the constitutional units comprising the residue of the alpha, beta-ethylenically unsaturated carboxylic acids may comprise no more than 10% by weight, such as no more than 8% by weight, such as no more than 6% by weight, such as no more than 5% by weight, such as no more than 4% by weight, such as no more than 3% by weight, such as no more than 2% by weight, such as no more than 1.5% by weight, such as no more than 1.0% by weight, based on the total weight of the addition polymer. The constitutional units comprising the residue of the alpha, beta-ethylenically unsaturated carboxylic acids may comprise 0.5% to 10% by weight, such as 0.5% to 8% by weight, such as 0.5% to 6% by weight, such as 0.5% by to 5% by weight, such as 0.5% to 4% by weight, such as 0.5% to 3% by weight, such as 0.5% to 2% by weight, such as 0.5% to 1.5% by weight, such as 0.5% to 1.0% by weight, such as 1% to 10% by weight, such as 1% to 8% by weight, such as 1% to 6% by weight, such as 1% by to 5% by weight, such as 1% to 4% by weight, such as 1% to 3% by weight, such as 1% to 2% by weight, such as 1% to 1.5% by weight, such as 1.5% to 10% by weight, such as 1.5% to 8% by weight, such as 1.5% to 6% by weight, such as 1.5% by to 5% by weight, such as 1.5% to 4% by weight, such as 1.5% to 3% by weight, such as 1.5% to 2% by weight, based on the total weight of the addition polymer. The addition polymer may be derived from a reaction mixture comprising the alpha, beta-ethylenically unsaturated carboxylic acids in an amount of 0.5% to 10% by weight, such as 0.5% to 8% by weight, such as 0.5% to 6% by weight, such as 0.5% by to 5% by weight, such as 0.5% to 4% by weight, such as 0.5% to 3% by weight, such as 0.5% to 2% by weight, such as 0.5% to 1.5% by weight, such as 0.5% to 1.0% by weight, such as 1% to 10% by weight, such as 1% to 8% by weight, such as 1% to 6% by weight, such as 1% by to 5% by weight, such as 1% to 4% by weight, such as 1% to 3% by weight, such as 1% to 2% by weight, such as 1% to 1.5% by weight, such as 1.5% to 10% by weight, such as 1.5% to 8% by weight, such as 1.5% to 6% by weight, such as 1.5% by to 5% by weight, such as 1.5% to 4% by weight, such as 1.5% to 3% by weight, such as 1.5% to 2% by weight, based on the total weight of polymerizable monomers used in the reaction mixture. The inclusion of constitutional units comprising the residue of an alpha, beta-ethylenically unsaturated carboxylic acids in the addition polymer results in an addition polymer comprising at least one carboxylic acid group.

The addition polymer optionally may comprise constitutional units comprising the residue of an ethylenically unsaturated monomer comprising a heterocyclic group. Non-limiting examples of ethylenically unsaturated monomers comprising a heterocyclic group include epoxy functional ethylenically unsaturated monomers (e.g., glycidyl (meth)acrylate), vinyl pyrrolidone and vinyl caprolactam, among others. The constitutional units comprising the residue of the ethylenically unsaturated monomers comprising a heterocyclic group may, if present, comprise at least 0.5% by weight, such as at least 1% by weight, such as at least 2% by weight, such as at least 3% by weight, such as at least 4% by weight, such as at least 5% by weight, such as at least 8% by weight, based on the total weight of the addition polymer. The constitutional units comprising the residue of the ethylenically unsaturated monomers comprising a heterocyclic group may, if present, comprise no more than 20% by weight, such as no more than 15% by weight, such as no more than 10% by weight, such as no more than 5% by weight, based on the total weight of the addition polymer. The constitutional units comprising the residue of the ethylenically unsaturated monomers comprising a heterocyclic group may comprise 0% to 20% by weight, such as 0.5% to 20% by weight, such as 0.5% to 15% by weight, such as 0.5% to 10% by weight, such as 0.5% to 5% by weight, such as 1% to 20% by weight, such as 1% to 15% by weight, such as 1% to 10% by weight, such as 1% to 5% by weight, such as 2% to 20% by weight, such as 2% to 15% by weight, such as 2% to 10% by weight, such as 2% to 5% by weight, such as 3% to 20% by weight, such as 3% to 15% by weight, such as 3% to 10% by weight, such as 3% to 5% by weight, such as 4% to 20% by weight, such as 4% to 15% by weight, such as 4% to 10% by weight, such as 4% to 5% by weight, such as 5% to 20% by weight, such as 5% to 15% by weight, such as 5% to 10% by weight, such as 8% to 20% by weight, such as 8% to 15% by weight, such as 8% to 10% by weight, based on the total weight of the addition polymer. The addition polymer may be derived from a reaction mixture comprising the ethylenically unsaturated monomers comprising a heterocyclic group in an amount of such as 0.5% to 20% by weight, such as 0.5% to 15% by weight, such as 0.5% to 10% by weight, such as 0.5% to 5% by weight, such as 1% to 20% by weight, such as 1% to 15% by weight, such as 1% to 10% by weight, such as 1% to 5% by weight, such as 2% to 20% by weight, such as 2% to 15% by weight, such as 2% to 10% by weight, such as 2% to 5% by weight, such as 3% to 20% by weight, such as 3% to 15% by weight, such as 3% to 10% by weight, such as 3% to 5% by weight, such as 4% to 20% by weight, such as 4% to 15% by weight, such as 4% to 10% by weight, such as 4% to 5% by weight, such as 5% to 20% by weight, such as 5% to 15% by weight, such as 5% to 10% by weight, such as 8% to 20% by weight, such as 8% to 15% by weight, such as 8% to 10% by weight, based on the total weight of polymerizable monomers used in the reaction mixture.

As noted above, the addition polymer may optionally comprise constitutional units comprising the residue of a self-crosslinking monomer, and the addition polymer may comprise a self-crosslinking addition polymer. As used herein, the term “self-crosslinking monomer” refers to monomers that incorporate functional groups that may react with active hydrogen functional groups present on the addition polymer to form a crosslink between the addition polymer or more than one addition polymer, and the term “self-crosslinking monomer” expressly excludes monomers having silicon-containing groups. Non-limiting examples of self-crosslinking monomers include N-alkoxymethyl (meth)acrylamide monomers such as N-butoxymethyl (meth)acrylamide and N-isopropoxymethyl (meth)acrylamide. The constitutional units comprising the residue of the self-crosslinking monomer may comprise at least 0.5% by weight, such as at least 1% by weight, such as at least 1.5% by weight, based on the total weight of the addition polymer. The constitutional units comprising the residue of the self-crosslinking monomer may comprise no more than 20% by weight, such as no more than 15% by weight, such as no more than 8% by weight, such as no more than 6% by weight, such as no more than 5% by weight, such as no more than 4% by weight, such as no more than 3% by weight, such as no more than 2% by weight, such as no more than 1.5% by weight, such as no more than 1.0% by weight, based on the total weight of the addition polymer. The constitutional units comprising the residue of the self-crosslinking monomer may comprise 0.5% to 20% by weight, such as 0.5% to 15% by weight, such as 0.5% to 10% by weight, such as 0.5% to 8% by weight, such as 0.5% to 6% by weight, such as 0.5% by to 5% by weight, such as 0.5% to 4% by weight, such as 0.5% to 3% by weight, such as 0.5% to 2% by weight, such as 0.5% to 1.5% by weight, such as 0.5% to 1.0% by weight, such as 1% to 20% by weight, such as 1% to 15% by weight, such as 1% to 10% by weight, such as 1% to 8% by weight, such as 1% to 6% by weight, such as 1% by to 5% by weight, such as 1% to 4% by weight, such as 1% to 3% by weight, such as 1% to 2% by weight, such as 1% to 1.5% by weight, such as 1.5% to 20% by weight, such as 1.5% to 15% by weight, such as 1.5% to 10% by weight, such as 1.5% to 8% by weight, such as 1.5% to 6% by weight, such as 1.5% by to 5% by weight, such as 1.5% to 4% by weight, such as 1.5% to 3% by weight, such as 1.5% to 2% by weight, based on the total weight of the addition polymer. The addition polymer may be derived from a reaction mixture comprising the self-crosslinking monomer in an amount of 0.5% to 20% by weight, such as 0.5% to 15% by weight, such as 0.5% to 10% by weight, such as 0.5% to 8% by weight, such as 0.5% to 6% by weight, such as 0.5% by to 5% by weight, such as 0.5% to 4% by weight, such as 0.5% to 3% by weight, such as 0.5% to 2% by weight, such as 0.5% to 1.5% by weight, such as 0.5% to 1.0% by weight, such as 1% to 20% by weight, such as 1% to 15% by weight, such as 1% to 10% by weight, such as 1% to 8% by weight, such as 1% to 6% by weight, such as 1% by to 5% by weight, such as 1% to 4% by weight, such as 1% to 3% by weight, such as 1% to 2% by weight, such as 1% to 1.5% by weight, such as 1.5% to 20% by weight, such as 1.5% to 15% by weight, such as 1.5% to 10% by weight, such as 1.5% to 8% by weight, such as 1.5% to 6% by weight, such as 1.5% by to 5% by weight, such as 1.5% to 4% by weight, such as 1.5% to 3% by weight, such as 1.5% to 2% by weight, based on the total weight of polymerizable monomers used in the reaction mixture.

The addition polymer may optionally comprise constitutional units comprising the residue of a vinyl aromatic compound. Non-limiting examples of vinyl aromatic compounds includes styrene, alpha-methyl styrene, alpha-chlorostyrene and vinyl toluene. The constitutional units comprising the residue of the vinyl aromatic compound may comprise at least 1% by weight, such as at least 5% by weight, such as at least 10% by weight, such as at least 15% by weight, such as at least 20% by weight, such as at least 25% by weight, based on the total weight of the addition polymer. The constitutional units comprising the residue of the vinyl aromatic compound may comprise no more than 80% by weight, such as no more than 65% by weight, such as no more than 50% by weight, such as no more than 40% by weight, such as no more than 30% by weight, such as no more than 20% by weight, such as no more than 15% by weight, such as no more than 10% by weight, based on the total weight of the addition polymer. The constitutional units comprising the residue of the vinyl aromatic compound may comprise 1% to 80% by weight, such as 1% to 65% by weight, such as 1% to 50% by weight, such as 1% to 40% by weight, such as 1% to 30% by weight, such as 1% to 20% by weight, such as 1% to 15% by weight, such as 1% to 10% by weight, such as 5% to 80% by weight, such as 5% to 65% by weight, such as 5% to 50% by weight, such as 5% to 40% by weight, such as 5% to 30% by weight, such as 5% to 20% by weight, such as 5% to 15% by weight, such as 5% to 10% by weight, such as 10% to 80% by weight, such as 10% to 65% by weight, such as 10% to 50% by weight, such as 10% to 40% by weight, such as 10% to 30% by weight, such as 10% to 20% by weight, such as 10% to 15% by weight, such as 15% to 80% by weight, such as 15% to 65% by weight, such as 15% to 50% by weight, such as 15% to 40% by weight, such as 15% to 30% by weight, such as 15% to 20% by weight, such as 20% to 80% by weight, such as 20% to 65% by weight, such as 20% to 50% by weight, such as 20% to 40% by weight, such as 20% to 30% by weight, such as 25% to 80% by weight, such as 25% to 65% by weight, such as 25% to 50% by weight, such as 25% to 40% by weight, such as 25% to 30% by weight, based on the total weight of the addition polymer. The addition polymer may be derived from a reaction mixture comprising the vinyl aromatic compound in an amount of such as 1% to 80% by weight, such as 1% to 65% by weight, such as 1% to 50% by weight, such as 1% to 40% by weight, such as 1% to 30% by weight, such as 1% to 20% by weight, such as 1% to 15% by weight, such as 1% to 10% by weight, such as 5% to 80% by weight, such as 5% to 65% by weight, such as 5% to 50% by weight, such as 5% to 40% by weight, such as 5% to 30% by weight, such as 5% to 20% by weight, such as 5% to 15% by weight, such as 5% to 10% by weight, such as 10% to 80% by weight, such as 10% to 65% by weight, such as 10% to 50% by weight, such as 10% to 40% by weight, such as 10% to 30% by weight, such as 10% to 20% by weight, such as 10% to 15% by weight, such as 15% to 80% by weight, such as 15% to 65% by weight, such as 15% to 50% by weight, such as 15% to 40% by weight, such as 15% to 30% by weight, such as 15% to 20% by weight, such as 20% to 80% by weight, such as 20% to 65% by weight, such as 20% to 50% by weight, such as 20% to 40% by weight, such as 20% to 30% by weight, such as 25% to 80% by weight, such as 25% to 65% by weight, such as 25% to 50% by weight, such as 25% to 40% by weight, such as 25% to 30% by weight, based on the total weight of polymerizable monomers used in the reaction mixture.

The addition polymer may optionally comprise constitutional units comprising the residue of a vinyl ester monomer. As used herein, a “vinyl ester” monomer refers to a compound having the structure C═C—O—C(O)—R, wherein R is an alkyl group having 1 to 5 carbon atoms. Non-limiting examples of vinyl ester monomers include vinyl acetate, vinyl propionate, and the like. The constitutional units comprising the residue of the vinyl ester monomer may comprise at least 1% by weight, such as at least 5% by weight, such as at least 10% by weight, such as at least 15% by weight, such as at least 20% by weight, such as at least 25% by weight, based on the total weight of the addition polymer. The constitutional units comprising the residue of the vinyl ester monomer may comprise no more than 80% by weight, such as no more than 65% by weight, such as no more than 50% by weight, such as no more than 40% by weight, such as no more than 30% by weight, such as no more than 20% by weight, such as no more than 15% by weight, such as no more than 10% by weight, based on the total weight of the addition polymer. The constitutional units comprising the residue of the vinyl ester monomer may comprise 1% to 80% by weight, such as 1% to 65% by weight, such as 1% to 50% by weight, such as 1% to 40% by weight, such as 1% to 30% by weight, such as 1% to 20% by weight, such as 1% to 15% by weight, such as 1% to 10% by weight, such as 5% to 80% by weight, such as 5% to 65% by weight, such as 5% to 50% by weight, such as 5% to 40% by weight, such as 5% to 30% by weight, such as 5% to 20% by weight, such as 5% to 15% by weight, such as 5% to 10% by weight, such as 10% to 80% by weight, such as 10% to 65% by weight, such as 10% to 50% by weight, such as 10% to 40% by weight, such as 10% to 30% by weight, such as 10% to 20% by weight, such as 10% to 15% by weight, such as 15% to 80% by weight, such as 15% to 65% by weight, such as 15% to 50% by weight, such as 15% to 40% by weight, such as 15% to 30% by weight, such as 15% to 20% by weight, such as 20% to 80% by weight, such as 20% to 65% by weight, such as 20% to 50% by weight, such as 20% to 40% by weight, such as 20% to 30% by weight, such as 25% to 80% by weight, such as 25% to 65% by weight, such as 25% to 50% by weight, such as 25% to 40% by weight, such as 25% to 30% by weight, based on the total weight of the addition polymer. The addition polymer may be derived from a reaction mixture comprising the vinyl ester monomer in an amount of such as 1% to 80% by weight, such as 1% to 65% by weight, such as 1% to 50% by weight, such as 1% to 40% by weight, such as 1% to 30% by weight, such as 1% to 20% by weight, such as 1% to 15% by weight, such as 1% to 10% by weight, such as 5% to 80% by weight, such as 5% to 65% by weight, such as 5% to 50% by weight, such as 5% to 40% by weight, such as 5% to 30% by weight, such as 5% to 20% by weight, such as 5% to 15% by weight, such as 5% to 10% by weight, such as 10% to 80% by weight, such as 10% to 65% by weight, such as 10% to 50% by weight, such as 10% to 40% by weight, such as 10% to 30% by weight, such as 10% to 20% by weight, such as 10% to 15% by weight, such as 15% to 80% by weight, such as 15% to 65% by weight, such as 15% to 50% by weight, such as 15% to 40% by weight, such as 15% to 30% by weight, such as 15% to 20% by weight, such as 20% to 80% by weight, such as 20% to 65% by weight, such as 20% to 50% by weight, such as 20% to 40% by weight, such as 20% to 30% by weight, such as 25% to 80% by weight, such as 25% to 65% by weight, such as 25% to 50% by weight, such as 25% to 40% by weight, such as 25% to 30% by weight, based on the total weight of polymerizable monomers used in the reaction mixture.

The addition polymer may optionally comprise constitutional units comprising the residue of other alpha, beta-ethylenically unsaturated monomers. Non-limiting examples of other alpha, beta-ethylenically unsaturated monomers include organic nitriles such as acrylonitrile and methacrylonitrile; allyl monomers such as allyl chloride and allyl cyanide; monomeric dienes such as 1,3-butadiene and 2-methyl-1,3-butadiene; and acetoacetoxyalkyl (meth)acrylates such as acetoacetoxyethyl methacrylate (AAEM) (which may be self-crosslinking). The constitutional units comprising the residue of the other alpha, beta-ethylenically unsaturated monomers may comprise at least at least 0.5% by weight, such as at least 1% by weight, such as at least 1.5% by weight, based on the total weight of the addition polymer. The constitutional units comprising the residue of the other alpha, beta-ethylenically unsaturated monomers may comprise no more than 20% by weight, such as no more than 15% by weight, such as no more than 8% by weight, such as no more than 6% by weight, such as no more than 5% by weight, such as no more than 4% by weight, such as no more than 3% by weight, such as no more than 2% by weight, such as no more than 1.5% by weight, such as no more than 1.0% by weight, based on the total weight of the addition polymer. The constitutional units comprising the residue of the other alpha, beta-ethylenically unsaturated monomers may comprise 0.5% to 20% by weight, such as 0.5% to 15% by weight, such as 0.5% to 10% by weight, such as 0.5% to 8% by weight, such as 0.5% to 6% by weight, such as 0.5% by to 5% by weight, such as 0.5% to 4% by weight, such as 0.5% to 3% by weight, such as 0.5% to 2% by weight, such as 0.5% to 1.5% by weight, such as 0.5% to 1.0% by weight, such as 1% to 20% by weight, such as 1% to 15% by weight, such as 1% to 10% by weight, such as 1% to 8% by weight, such as 1% to 6% by weight, such as 1% by to 5% by weight, such as 1% to 4% by weight, such as 1% to 3% by weight, such as 1% to 2% by weight, such as 1% to 1.5% by weight, such as 1.5% to 20% by weight, such as 1.5% to 15% by weight, such as 1.5% to 10% by weight, such as 1.5% to 8% by weight, such as 1.5% to 6% by weight, such as 1.5% by to 5% by weight, such as 1.5% to 4% by weight, such as 1.5% to 3% by weight, such as 1.5% to 2% by weight, based on the total weight of the addition polymer. The addition polymer may be derived from a reaction mixture comprising the other alpha, beta-ethylenically unsaturated monomers in an amount of 0.5% to 20% by weight, such as 0.5% to 15% by weight, such as 0.5% to 10% by weight, such as 0.5% to 8% by weight, such as 0.5% to 6% by weight, such as 0.5% by to 5% by weight, such as 0.5% to 4% by weight, such as 0.5% to 3% by weight, such as 0.5% to 2% by weight, such as 0.5% to 1.5% by weight, such as 0.5% to 1.0% by weight, such as 1% to 20% by weight, such as 1% to 15% by weight, such as 1% to 10% by weight, such as 1% to 8% by weight, such as 1% to 6% by weight, such as 1% by to 5% by weight, such as 1% to 4% by weight, such as 1% to 3% by weight, such as 1% to 2% by weight, such as 1% to 1.5% by weight, such as 1.5% to 20% by weight, such as 1.5% to 15% by weight, such as 1.5% to 10% by weight, such as 1.5% to 8% by weight, such as 1.5% to 6% by weight, such as 1.5% by to 5% by weight, such as 1.5% to 4% by weight, such as 1.5% to 3% by weight, such as 1.5% to 2% by weight, based on the total weight of polymerizable monomers used in the reaction mixture.

The addition polymer may comprise functional groups. The functional groups may comprise, for example, active hydrogen functional groups, heterocyclic groups, silicon-containing functional groups, and any combination thereof, and the functional groups may be incorporated through the use of the monomers discussed above as well as any other functionalized ethylenically unsaturated monomer or post-reacted compound. As used herein, the term “active hydrogen functional groups” refers to those groups that are reactive with isocyanates as determined by the Zerewitinoff test described in the JOURNAL OF THE AMERICAN CHEMICAL SOCIETY, Vol. 49, page 3181 (1927), and include, for example, hydroxyl groups, primary or secondary amino groups, carboxylic acid groups, and thiol groups. As used herein, the term “heterocyclic group” refers to a cyclic group containing at least two different elements in its ring such as a cyclic moiety having at least one atom in addition to carbon in the ring structure, such as, for example, oxygen, nitrogen or sulfur. Non-limiting examples of heterocylic groups include epoxides, aziridines, thioepoxides, lactams and lactones. In addition, when epoxide functional groups are present on the addition polymer, the epoxide functional groups on the addition polymer optionally may be post-reacted with an acid, such as a beta-hydroxy functional acid. Non-limiting examples of beta-hydroxy functional acids include citric acid, tartaric acid, and/or an aromatic acid, such as 3-hydroxy-2-naphthoic acid. The ring opening reaction of the epoxide functional group will yield hydroxyl functional groups on the (meth)acrylic.

The monomers and relative amounts may be selected such that the resulting addition polymer has a Tg of 100° C. or less. The resulting addition polymer may have a Tg of, for example, at least −50° C., such as at least −40° C., such as −30° C., such as, −20° C., such as −15° C., such as −10° C., such as −5° C., such as 0° C. The resulting addition polymer may have a Tg of, for example, no more than +70° C., such as no more than +60° C., such as no more than +50° C., such as no more than +40° C., such as no more than +25° C., such as no more than +15° C., such as no more than +10° C., such as no more than +5° C., such as no more than 0° C. The resulting addition polymer may have a Tg of, for example, −50 to +70° C., such as −50 to +60° C., such as −50 to +50° C., such as −50 to +40° C., such as −50 to +25° C., such as −50 to +20° C., such as −50 to +15° C., such as −50 to +10° C., such as −50 to +5° C., such as −50 to 0° C., such as −40 to +50° C., such as −40 to +40° C., such as −40 to +25° C., such as −40 to +20° C., such as −40 to +15° C., such as −40 to +10° C., such as −40 to +5° C., such as −40 to 0° C., such as −30 to +50° C., such as −30 to +40° C., such as −30 to +25° C., such as −30 to +20° C., such as −30 to +15° C., such as −30 to +10° C., such as −30 to +5° C., such as −30 to 0° C., such as −20 to +50° C., such as −20 to +40° C., such as −20 to +25° C., such as −20 to +20° C., such as −20 to +15° C., such as −20 to +10° C., such as −20 to +5° C., such as −20 to 0° C., such as −15 to +50° C., such as −15 to +40° C., such as −15 to +25° C., such as −15 to +20° C., such as −15 to +15° C., such as −15 to +10° C., such as −15 to +5° C., such as −15 to 0° C., such as −10 to +50° C., such as −10 to +40° C., such as −10 to +25° C., such as −10 to +20° C., such as −10 to +15° C., such as −10 to +10° C., such as −10 to +5° C., such as −10 to 0° C., such as −5 to +50° C., such as −5 to +40° C., such as −5 to +25° C., such as −5 to +20° C., such as −5 to +15° C., such as −5 to +10° C., such as −5 to +5° C., such as −5 to 0° C., such as 0 to +50° C., such as 0 to +40° C., such as 0 to +25° C., such as 0 to +20° C., such as 0 to +15° C. A lower Tg that is below 0° C. may be desirable to ensure acceptable battery performance at low temperature.

The addition polymer may have a number average molecular weight of at least 1,000 g/mol, such as at least 1,500 g/mol, such as at least 2,500 g/mol, such as at least 5,000 g/mol, such as at least 7,500 g/mol, such at least 10,000 g/mol. The addition polymer may have a number average molecular weight of no more than 100,000 g/mol, such as no more than 75,000 g/mol, such as no more than 50,000 g/mol, such as no more than 25,000 g/mol, such as no more than 20,000 g/mol, such as no more than 15,000 g/mol, such as no more than 10,000 g/mol, such as no more than 7.500 g/mol. The addition polymer may have a number average molecular weight of 1,000 to 100,000 g/mol, such as 1,000 to 75,000 g/mol, such as 1,000 to 50,000 g/mol, such as 1,000 to 25,000 g/mol, such as 1,000 to 20,000 g/mol, such as 1,000 to 15,000 g/mol, such as 1,000 to 12,500 g/mol, such as 1,000 to 10,000 g/mol, such as 1,000 to 7,500 g/mol, such as 1,500 to 100,000 g/mol, such as 1,500 to 75,000 g/mol, such as 1,500 to 50,000 g/mol, such as 1,500 to 25,000 g/mol, such as 1,500 to 20,000 g/mol, such as 1,500 to 15,000 g/mol, such as 1,500 to 12,500 g/mol, such as 1,500 to 10,000 g/mol, such as 1,500 to 7,500 g/mol, such as 2,500 to 100,000 g/mol, such as 2,500 to 75,000 g/mol, such as 2,500 to 50,000 g/mol, such as 2,500 to 25,000 g/mol, such as 2,500 to 20,000 g/mol, such as 2,500 to 15,000 g/mol, such as 2,500 to 12,500 g/mol, such as 2,500 to 10,000 g/mol, such as 2,500 to 7,500 g/mol, 5,000 to 100,000 g/mol, such as 5,000 to 75,000 g/mol, such as 5,000 to 50,000 g/mol, such as 5,000 to 25,000 g/mol, such as 5,000 to 20,000 g/mol, such as 5,000 to 15,000 g/mol, such as 5,000 to 12,500 g/mol, such as 5,000 to 10,000 g/mol, such as 5,000 to 7,500 g/mol, 7,500 to 100,000 g/mol, such as 7,500 to 75,000 g/mol, such as 7,500 to 50,000 g/mol, such as 7,500 to 25,000 g/mol, such as 7,500 to 20,000 g/mol, such as 7,500 to 15,000 g/mol, such as 7,500 to 12,500 g/mol, such as 7,500 to 10,000 g/mol, 10,000 to 100,000 g/mol, such as 10,000 to 75,000 g/mol, such as 10,000 to 50,000 g/mol, such as 10,000 to 25,000 g/mol, such as 10,000 to 20,000 g/mol, such as 10,000 to 15,000 g/mol, such as 10,000 to 12,500 g/mol.

The addition polymer may have a weight average molecular weight of at least at least 2,000 g/mol, such as at least 5,000 g/mol, such as at least 10,000 g/mol, such as at least 15,000 g/mol, such at least 20,000 g/mol. The addition polymer may have a weight average molecular weight of no more than 1,000,000 g/mol, such as no more than 500,000 g/mol, such as no more than 200,000 g/mol, such as no more than 150,000 g/mol, such as no more than 100,000 g/mol, such as no more than 50,000 g/mol, such as no more than 40,000 g/mol, such as no more than 30,000 g/mol, such as no more than 20,000 g/mol, such as no more than 15,000 g/mol. The addition polymer may have a weight average molecular weight of 2,000 to 1,000,000 g/mol, such as 2,000 to 500,000 g/mol, such as 2,000 to 200,000 g/mol, such as 2,000 to 150,000 g/mol, such as 2,000 to 100,000 g/mol, such as 2,000 to 50,000 g/mol, such as 2,000 to 40,000 g/mol, such as 2,000 to 30,000 g/mol, such as 2,000 to 25,000 g/mol, such as 2,000 to 20,000 g/mol, such as 2,000 to 15,000 g/mol, such as 5,000 to 1,000,000 g/mol, such as 5,000 to 500,000 g/mol, such as 5,000 to 200,000 g/mol, such as 5,000 to 150,000 g/mol, such as 5,000 to 100,000 g/mol, such as 5,000 to 50,000 g/mol, such as 5,000 to 40,000 g/mol, such as 5,000 to 30,000 g/mol, such as 5,000 to 25,000 g/mol, such as 5,000 to 20,000 g/mol, such as 5,000 to 15,000 g/mol, such as 10,000 to 1,000,000 g/mol, such as 10,000 to 500,000 g/mol, such as 10,000 to 200,000 g/mol, such as 10,000 to 150,000 g/mol, such as 10,000 to 100,000 g/mol, such as 10,000 to 50,000 g/mol, such as 10,000 to 40,000 g/mol, such as 10,000 to 30,000 g/mol, such as 10,000 to 25,000 g/mol, such as 10,000 to 20,000 g/mol, such as 10,000 to 15,000 g/mol, such as 15,000 to 1,000,000 g/mol, such as 15,000 to 500,000 g/mol, such as 15,000 to 200,000 g/mol, such as 15,000 to 150,000 g/mol, such as 15,000 to 100,000 g/mol, such as 15,000 to 50,000 g/mol, such as 15,000 to 40,000 g/mol, such as 15,000 to 30,000 g/mol, such as 15,000 to 25,000 g/mol, such as 15,000 to 20,000 g/mol, such as 20,000 to 200,000 g/mol, such as 20,000 to 150,000 g/mol, such as 20,000 to 100,000 g/mol, such as 20,000 to 50,000 g/mol, such as 20,000 to 40,000 g/mol, such as 20,000 to 30,000 g/mol, such as 20,000 to 25,000 g/mol.

The addition polymer may be prepared by conventional free radical initiated solution polymerization techniques in which the polymerizable monomers are dissolved in an organic medium comprising a solvent or a mixture of solvents and polymerized in the presence of a free radical initiator until conversion is complete.

Examples of free radical initiators are those which are soluble in the mixture of monomers or organic medium such as azobisisobutyronitrile, azobis(alpha, gamma-methylvaleronitrile), tertiary-butyl perbenzoate, tertiary-butyl peracetate, benzoyl peroxide, ditertiary-butyl peroxide, ditertiary-amyl peroxide, and tertiary amyl peroxy 2-ethylhexyl carbonate.

Optionally, a chain transfer agent which is soluble in the mixture of monomers such as alkyl mercaptans, for example, tertiary-dodecyl mercaptan; ketones such as methyl ethyl ketone, chlorohydrocarbons such as chloroform can be used. A chain transfer agent provides control over the molecular weight to give products having required viscosity for various coating applications.

To prepare the addition polymer, the solvent may be first heated to reflux and the mixture of polymerizable monomers and the free radical initiator may be separately added slowly to the refluxing solvent. The reaction mixture is then held at polymerizing temperatures so as to reduce the free monomer content, such as to below 1.0 percent and usually below 0.5 percent, based on the total weight of the mixture of polymerizable monomers.

The addition polymer may be prepared by a continuous stirred tank reactor process. For example, monomer, initiator, and optional solvent may be added to a first continuous stirred-tank reactor and held under elevated temperature and pressure for a predetermined residence time; the product may then be continuously fed into a second continuous stirred tank reactor and be combined with addition monomer and initiator and held under elevated temperature and pressure for a predetermined residence time; and the product of the second continuous stirred tank reactor may then be continuously fed into a collection vessel at a rate that maintained a constant fill level in the second continuous stirred reaction tank reactor as monomer and initiator is continuously added to the second continuous stirred reaction tank reactor. An exemplary process is included in the Examples section.

The addition polymer may be present in the binder in amounts of at least 0.1% by weight, such as at least 1% by weight, such as at least 2% by weight, such as at least 3% by weight, such as at least 4% by weight, such as at least 5% by weight, based on the total weight of the binder solids. The addition polymer may be present in the binder in amounts of no more than 25% by weight, such as no more than 20% by weight, such as no more than 15% by weight, such as no more than 12.5% by weight, such as no more than 10% by weight, such as no more than 5% by weight, based on the total weight of the binder solids. The addition polymer may be present in the binder in amounts of 0.1% to 25% by weight, such as 0.1% to 20% by weight, such as 0.1% to 15% by weight, such as 0.1% to 12.5% by weight, such as 0.1% to 10% by weight, such as 0.1% to 5% by weight, such as 1% to 25% by weight, such as 1% to 20% by weight, such as 1% to 15% by weight, such as 1% to 12.5% by weight, such as 1% to 10% by weight, such as 1% to 5% by weight, such as 2% to 25% by weight, such as 2% to 20% by weight, such as 2% to 15% by weight, such as 2% to 12.5% by weight, such as 2% to 10% by weight, such as 2% to 5% by weight, such as 3% to 25% by weight, such as 3% to 20% by weight, such as 3% to 15% by weight, such as 3% to 12.5% by weight, such as 3% to 10% by weight, such as 3% to 5% by weight, such as 4% to 25% by weight, such as 4% to 20% by weight, such as 4% to 15% by weight, such as 4% to 12.5% by weight, such as 4% to 10% by weight, such as 4% to 5% by weight, such as 5% to 25% by weight, such as 5% to 20% by weight, such as 5% to 15% by weight, such as 5% to 12.5% by weight, such as 5% to 10% by weight, based on the total weight of the binder solids.

The addition polymer may be present in the slurry composition in an amount of at least 0.1% by weight, such as at least 1% by weight, such as at least 1.3% by weight, such as at least 1.5% by weight, such as at least 1.9% by weight, based on the total solids weight of the slurry composition. The addition polymer may be present in the slurry composition in an amount of no more than 10% by weight, such as no more than 6% by weight, such as no more than 4.5% by weight, such as no more than 2.9% by weight, such as no more than 2.5% by weight, such as no more than 2% by weight, based on the total solids weight of the slurry composition. The addition polymer may be present in the slurry composition in an amount of 0.1% to 10% by weight, such as 0.1% to 6% by weight, such as 0.1% to 4.5% by weight, such as 0.1% to 2.9% by weight, such as 0.1% to 2.5% by weight, such as 0.1% to 2% by weight, such as 1% to 10% by weight, such as 1% to 6% by weight, such as 1% to 4.5% by weight, such as 1% to 2.9% by weight, such as 1% to 2.5% by weight, such as 1% to 2% by weight, such as 1.3% to 10% by weight, such as 1.3% to 6% by weight, such as 1.3% to 4.5% by weight, such as 1.3% to 2.9% by weight, such as 1.3% to 2.5% by weight, such as 1.3% to 2% by weight, such as 1.5% to 10% by weight, such as 1.5% to 6% by weight, such as 1.5% to 4.5% by weight, such as 1.5% to 2.9% by weight, such as 1.5% to 2.5% by weight, such as 1.5% to 2% by weight, such as 1.9% to 10% by weight, such as 1.9% to 6% by weight, such as 1.9% to 4.5% by weight, such as 1.9% to 2.9% by weight, such as 1.9% to 2.5% by weight, such as 1.9% to 2% by weight, such as 1% to 10% by weight, such as 1% to 6% by weight, such as 1% to 4.5% by weight, such as 1% to 2.9% by weight, such as 1% to 2.5% by weight, such as 1% to 2% by weight, based on the total solids weight of the slurry composition.

The binder composition and/or slurry composition may optionally further comprise a non-polymeric alkoxysilane compound. As used herein, the term “non-polymeric alkoxysilane compound” refers to a compound comprising at least one mono-, di-, or tri-alkoxysilane functional group that is not a polymerization product of unsaturated monomers. The non-polymeric alkoxysilane compound may comprise, for example, an amino silane, an epoxy silane, or a mercapto-silane. The alkoxy group(s) of the non-polymeric alkoxysilane compound may comprise, for example, methoxy, ethoxy, isopropoxy, butoxy, ter-butoxy, or triethanolamine (silatrane), as well as combinations thereof. The non-polymeric alkoxysilane compound may be according to the general formula X—R₁—Si(OR₂)₃, wherein X is —NH₂, —SH, or oxygen bound to adjacent carbon atoms; R₁ is an alkylene group; and R₂ is methyl, ethyl, isopropyl, butyl, ter-butyl, or in combination N(C₂H₂)₃ (i.e., triethanolamine (silatrane)). The non-polymeric alkoxysilane compound may have a number average molecular weight of less than 1,000 g/mol. Non-limiting examples include, for example, aminopropyltrimethoxysilane, aminopropyltriethoxysilane, 5,6-epoxyhexyltriethoxysilane, among others. The binder composition and/or slurry composition may also comprise combinations of the non-polymeric alkoxysilane compounds.

The non-polymeric alkoxysilane compound may be present in an amount of at least 0.1% by weight, such as at least 0.25% by weight, such as at least 0.5% by weight, such as at least 1% by weight, based on the total weight of the binder solids. The non-polymeric alkoxysilane compound may be present in an amount of no more than 10% by weight, such as no more than 5% by weight, such as no more than 3% by weight, based on the total weight of the binder solids. The non-polymeric alkoxysilane compound may be present in an amount of 0.1% to 10% by weight, such as 0.1% to 5% by weight, such as 0.1% to 3% by weight, such as 0.25% to 10% by weight, such as 0.25% to 5% by weight, such as 0.25% to 3% by weight, such as 0.5% to 10% by weight, such as 0.5% to 5% by weight, such as 0.5% to 3% by weight, such as 1% to 10% by weight, such as 1% to 5% by weight, such as 1% to 3% by weight, based on the total weight of the binder solids.

The binder composition and/or slurry composition may optionally further comprise a (meth)acrylic polymer. The (meth)acrylic polymer is different from the addition polymer and may be free of silicon-containing functional groups. The (meth)acrylic polymer may comprise constitutional units comprising the residue of one or more ethylenically unsaturated monomers. The (meth)acrylic polymer may be prepared by polymerizing a reaction mixture of alpha, beta-ethylenically unsaturated monomers that comprise one or more ethylenically unsaturated monomers. The (meth)acrylic polymer may be in the form of a block polymer, a random polymer, or a gradient polymer.

The (meth)acrylic polymer may comprise the constitutional units comprising the residue of, or be derived from, alkyl esters of (meth)acrylic acid, ethylenically unsaturated monomers comprising one or more active hydrogen groups, ethylenically unsaturated monomers comprising a heterocyclic group, ethylenically unsaturated monomers comprising a silicon-containing functional group, as well as other ethylenically unsaturated monomers. The (meth)acrylic polymer may comprise a functional group, and the functional group may be post-reacted with another compound. For example, epoxy functional groups on the resulting (meth)acrylic polymer incorporated through an epoxy functional monomer (e.g., glycidyl (meth)acrylate) may be post-reacted with a hydroxy-functional acid, such as a beta-hydroxy functional acid such as citric acid, tartaric acid, and/or 3-hydroxy-2-naphthoic acid, to result in hydroxyl functional groups on the (meth)acrylic polymer.

The (meth)acrylic polymer may optionally comprise constitutional units comprising the residue of an alkyl esters of (meth)acrylic acid containing from 1 to 18 carbon atoms in the alkyl group, such as 1 to 10 carbon atoms in the alkyl group. Non-limiting examples of alkyl esters of (meth)acrylic acid containing from 1 to 18 carbon atoms in the alkyl group include methyl (meth)acrylate, ethyl (meth)acrylate, butyl (meth)acrylate, hexyl (meth)acrylate, octyl (meth)acrylate, isodecyl(meth)acrylate, stearyl (meth)acrylate, 2-ethylhexyl (meth)acrylate, decyl(meth)acrylate and dodecyl (meth)acrylate. The constitutional units comprising the residue of the alkyl esters of (meth)acrylic acid containing from 1 to 18 carbon atoms in the alkyl group may comprise at least 30% by weight, such as at least 35% by weight, such as at least 40% by weight, such as at least 45% by weight, such as at least 47.5% by weight, based on the total weight of the (meth)acrylic polymer. The constitutional units comprising the residue of the alkyl esters of (meth)acrylic acid containing from 1 to 18 carbon atoms in the alkyl group may comprise no more than 96%, such as no more than 90%, such as no more than 85%, such as no more than 80%, such as no more than 75%, such as no more than 70%, such as no more than 65%, based on the total weight of the (meth)acrylic polymer. The constitutional units comprising the residue of the alkyl esters of (meth)acrylic acid containing from 1 to 18 carbon atoms in the alkyl group may comprise 30% to 96% by weight, such as 30% to 90% by weight, such as 30% to 85% by weight, such as 30% to 80% by weight, such as 30% to 75% by weight, such as 30% to 70% by weight, such as 30% to 65% by weight, such as 35% to 96% by weight, such as 35% to 90% by weight, such as 35% to 85% by weight, such as 35% to 80% by weight, such as 35% to 75% by weight, such as 35% to 70% by weight, such as 35% to 65% by weight, such as 40% to 96% by weight, such as 40% to 90% by weight, such as 40% to 85% by weight, such as 40% to 80% by weight, such as 40% to 75% by weight, such as 40% to 70% by weight, such as 40% to 65% by weight, such as 45% to 96% by weight, such as 45% to 90% by weight, such as 45% to 85% by weight, such as 45% to 80% by weight, such as 45% to 75% by weight, such as 45% to 70% by weight, such as 45% to 65% by weight, such as 47.5% to 96% by weight, such as 47.5% to 90% by weight, such as 47.5% to 85% by weight, such as 47.5% to 80% by weight, such as 47.5% to 75% by weight, such as 47.5% to 70% by weight, such as 47.5% to 65% by weight, based on the total weight of the (meth)acrylic polymer. The (meth)acrylic polymer may be derived from a reaction mixture comprising the alkyl esters of (meth)acrylic acid containing from 1 to 18 carbon atoms in the alkyl group in an amount of 30% to 96% by weight, such as 30% to 90% by weight, such as 30% to 85% by weight, such as 30% to 80% by weight, such as 30% to 75% by weight, such as 30% to 70% by weight, such as 30% to 65% by weight, such as 35% to 96% by weight, such as 35% to 90% by weight, such as 35% to 85% by weight, such as 35% to 80% by weight, such as 35% to 75% by weight, such as 35% to 70% by weight, such as 35% to 65% by weight, such as 40% to 96% by weight, such as 40% to 90% by weight, such as 40% to 85% by weight, such as 40% to 80% by weight, such as 40% to 75% by weight, such as 40% to 70% by weight, such as 40% to 65% by weight, such as 45% to 96% by weight, such as 45% to 90% by weight, such as 45% to 85% by weight, such as 45% to 80% by weight, such as 45% to 75% by weight, such as 45% to 70% by weight, such as 45% to 65% by weight, such as 47.5% to 96% by weight, such as 47.5% to 90% by weight, such as 47.5% to 85% by weight, such as 47.5% to 80% by weight, such as 47.5% to 75% by weight, such as 47.5% to 70% by weight, such as 47.5% to 65% by weight, based on the total weight of polymerizable monomers used in the reaction mixture.

The alkyl esters of (meth)acrylic acid containing from 1 to 18 carbon atoms in the alkyl group may comprise an alkyl ester of (meth)acrylic acid containing from 1 to 3 carbon atoms in the alkyl group such that the (meth)acrylic polymer optionally comprises constitutional units comprising the residue of an alkyl ester of (meth)acrylic acid containing from 1 to 3 carbon atoms in the alkyl group. Non-limiting examples of alkyl esters of (meth)acrylic acid containing from 1 to 3 carbon atoms in the alkyl group include methyl (meth)acrylate and ethyl (meth)acrylate. The constitutional units comprising the residue of the alkyl esters of (meth)acrylic acid containing from 1 to 3 carbon atoms in the alkyl group may comprise at least 30% by weight, such as at least 35% by weight, such as at least 40% by weight, such as at least 45% by weight, such as at least 47.5% by weight, based on the total weight of the (meth)acrylic polymer. The constitutional units comprising the residue of the alkyl esters of (meth)acrylic acid containing from 1 to 3 carbon atoms in the alkyl group may comprise no more than 96%, such as no more than 90%, such as no more than 85%, such as no more than 80%, such as no more than 75%, such as no more than 70%, such as no more than 65%, based on the total weight of the (meth)acrylic polymer. The constitutional units comprising the residue of the alkyl esters of (meth)acrylic acid containing from 1 to 3 carbon atoms in the alkyl group may comprise 30% to 96% by weight, such as 30% to 90% by weight, such as 30% to 85% by weight, such as 30% to 80% by weight, such as 30% to 75% by weight, such as 30% to 70% by weight, such as 30% to 65% by weight, such as 35% to 96% by weight, such as 35% to 90% by weight, such as 35% to 85% by weight, such as 35% to 80% by weight, such as 35% to 75% by weight, such as 35% to 70% by weight, such as 35% to 65% by weight, such as 40% to 96% by weight, such as 40% to 90% by weight, such as 40% to 85% by weight, such as 40% to 80% by weight, such as 40% to 75% by weight, such as 40% to 70% by weight, such as 40% to 65% by weight, such as 45% to 96% by weight, such as 45% to 90% by weight, such as 45% to 85% by weight, such as 45% to 80% by weight, such as 45% to 75% by weight, such as 45% to 70% by weight, such as 45% to 65% by weight, such as 47.5% to 96% by weight, such as 47.5% to 90% by weight, such as 47.5% to 85% by weight, such as 47.5% to 80% by weight, such as 47.5% to 75% by weight, such as 47.5% to 70% by weight, such as 47.5% to 65% by weight, based on the total weight of the (meth)acrylic polymer. The (meth)acrylic polymer may be derived from a reaction mixture comprising the alkyl esters of (meth)acrylic acid containing from 1 to 3 carbon atoms in the alkyl group in an amount of 30% to 96% by weight, such as 30% to 90% by weight, such as 30% to 85% by weight, such as 30% to 80% by weight, such as 30% to 75% by weight, such as 30% to 70% by weight, such as 30% to 65% by weight, such as 35% to 96% by weight, such as 35% to 90% by weight, such as 35% to 85% by weight, such as 35% to 80% by weight, such as 35% to 75% by weight, such as 35% to 70% by weight, such as 35% to 65% by weight, such as 40% to 96% by weight, such as 40% to 90% by weight, such as 40% to 85% by weight, such as 40% to 80% by weight, such as 40% to 75% by weight, such as 40% to 70% by weight, such as 40% to 65% by weight, such as 45% to 96% by weight, such as 45% to 90% by weight, such as 45% to 85% by weight, such as 45% to 80% by weight, such as 45% to 75% by weight, such as 45% to 70% by weight, such as 45% to 65% by weight, such as 47.5% to 96% by weight, such as 47.5% to 90% by weight, such as 47.5% to 85% by weight, such as 47.5% to 80% by weight, such as 47.5% to 75% by weight, such as 47.5% to 70% by weight, such as 47.5% to 65% by weight, based on the total weight of polymerizable monomers used in the reaction mixture for each (meth)acrylic polymer.

The alkyl esters of (meth)acrylic acid containing from 1 to 18 carbon atoms in the alkyl group may comprise an alkyl ester of (meth)acrylic acid containing from 4 to 18 carbon atoms in the alkyl group such that the (meth)acrylic polymer optionally comprises constitutional units comprising the residue of an alkyl ester of (meth)acrylic acid containing from 4 to 18 carbon atoms in the alkyl group. Non-limiting examples of alkyl esters of (meth)acrylic acid containing from 4 to 18 carbon atoms in the alkyl group include butyl (meth)acrylate, hexyl (meth)acrylate, octyl (meth)acrylate, isodecyl (meth)acrylate, stearyl (meth)acrylate, 2-ethylhexyl (meth)acrylate, decyl (meth)acrylate and dodecyl (meth)acrylate. The constitutional units comprising the residue of the alkyl esters of (meth)acrylic acid containing from 4 to 18 carbon atoms in the alkyl group may comprise at least 2% by weight, such as at least 5% by weight, such as at least 10% by weight, such as at least 15% by weight, such as at least 18% by weight, such as at least 18% by weight, based on the total weight of the (meth)acrylic polymer. The constitutional units comprising the residue of the alkyl esters of (meth)acrylic acid containing from 4 to 18 carbon atoms in the alkyl group may comprise no more than 60% by weight, such as no more than 50% by weight, such as no more than 45% by weight, such as no more than 40% by weight, such as no more than 35% by weight, based on the total weight of the (meth)acrylic polymer. The constitutional units comprising the residue of the alkyl esters of (meth)acrylic acid containing from 4 to 18 carbon atoms in the alkyl group may comprise 2% to 60% by weight, such as 2% to 50% by weight, such as 2% to 45% by weight, such as 2% to 40% by weight, such as 2% to 35% by weight, such as 5% to 60% by weight, such as 5% to 50% by weight, such as 5% to 45% by weight, such as 5% to 40% by weight, such as 5% to 35% by weight, such as 10% to 60% by weight, such as 10% to 50% by weight, such as 10% to 45% by weight, such as 10% to 40% by weight, such as 10% to 35% by weight, such as 15% to 60% by weight, such as 15% to 50% by weight, such as 15% to 45% by weight, such as 15% to 40% by weight, such as 15% to 35% by weight, such as 18% to 60% by weight, such as 18% to 50% by weight, such as 18% to 45% by weight, such as 18% to 40% by weight, such as 18% to 35% by weight, such as 20% to 60% by weight, such as 20% to 50% by weight, such as 20% to 45% by weight, such as 20% to 40% by weight, such as 20% to 35% by weight, based on the total weight of the (meth)acrylic polymer. The (meth)acrylic polymer may be derived from a reaction mixture comprising the alkyl esters of (meth)acrylic acid containing from 4 to 18 carbon atoms in the alkyl group in an amount of 2% to 60% by weight, such as 2% to 50% by weight, such as 2% to 45% by weight, such as 2% to 40% by weight, such as 2% to 35% by weight, such as 5% to 60% by weight, such as 5% to 50% by weight, such as 5% to 45% by weight, such as 5% to 40% by weight, such as 5% to 35% by weight, such as 10% to 60% by weight, such as 10% to 50% by weight, such as 10% to 45% by weight, such as 10% to 40% by weight, such as 10% to 35% by weight, such as 15% to 60% by weight, such as 15% to 50% by weight, such as 15% to 45% by weight, such as 15% to 40% by weight, such as 15% to 35% by weight, such as 18% to 60% by weight, such as 18% to 50% by weight, such as 18% to 45% by weight, such as 18% to 40% by weight, such as 18% to 35% by weight, such as 20% to 60% by weight, such as 20% to 50% by weight, such as 20% to 45% by weight, such as 20% to 40% by weight, such as 20% to 35% by weight, based on the total weight of polymerizable monomers used in the reaction mixture.

The (meth)acrylic polymer may optionally comprise constitutional units comprising the residue of a hydroxyalkyl ester. Non-limiting examples of hydroxyalkyl esters include hydroxyethyl (meth)acrylate and hydroxypropyl (meth)acrylate. The constitutional units comprising the residue of the hydroxyalkyl ester may comprise at least 0.5% by weight, such as at least 1% by weight, such as at least 1.5% by weight, based on the total weight of the (meth)acrylic polymer. The constitutional units comprising the residue of the hydroxyalkyl ester may comprise no more than 20% by weight, such as no more than 15% by weight, such as no more than 8% by weight, such as no more than 6% by weight, such as no more than 5% by weight, such as no more than 4% by weight, such as no more than 3% by weight, such as no more than 2% by weight, such as no more than 1.5% by weight, such as no more than 1.0% by weight, based on the total weight of the (meth)acrylic polymer. The constitutional units comprising the residue of the hydroxyalkyl ester may comprise 0.5% to 20% by weight, such as 0.5% to 15% by weight, such as 0.5% to 10% by weight, such as 0.5% to 8% by weight, such as 0.5% to 6% by weight, such as 0.5% by to 5% by weight, such as 0.5% to 4% by weight, such as 0.5% to 3% by weight, such as 0.5% to 2% by weight, such as 0.5% to 1.5% by weight, such as 0.5% to 1.0% by weight, such as 1% to 20% by weight, such as 1% to 15% by weight, such as 1% to 10% by weight, such as 1% to 8% by weight, such as 1% to 6% by weight, such as 1% by to 5% by weight, such as 1% to 4% by weight, such as 1% to 3% by weight, such as 1% to 2% by weight, such as 1% to 1.5% by weight, such as 1.5% to 20% by weight, such as 1.5% to 15% by weight, such as 1.5% to 10% by weight, such as 1.5% to 8% by weight, such as 1.5% to 6% by weight, such as 1.5% by to 5% by weight, such as 1.5% to 4% by weight, such as 1.5% to 3% by weight, such as 1.5% to 2% by weight, based on the total weight of the (meth)acrylic polymer. The (meth)acrylic polymer may be derived from a reaction mixture comprising the hydroxyalkyl ester in an amount of 0.5% to 20% by weight, such as 0.5% to 15% by weight, such as 0.5% to 10% by weight, such as 0.5% to 8% by weight, such as 0.5% to 6% by weight, such as 0.5% by to 5% by weight, such as 0.5% to 4% by weight, such as 0.5% to 3% by weight, such as 0.5% to 2% by weight, such as 0.5% to 1.5% by weight, such as 0.5% to 1.0% by weight, such as 1% to 20% by weight, such as 1% to 15% by weight, such as 1% to 10% by weight, such as 1% to 8% by weight, such as 1% to 6% by weight, such as 1% by to 5% by weight, such as 1% to 4% by weight, such as 1% to 3% by weight, such as 1% to 2% by weight, such as 1% to 1.5% by weight, such as 1.5% to 20% by weight, such as 1.5% to 15% by weight, such as 1.5% to 10% by weight, such as 1.5% to 8% by weight, such as 1.5% to 6% by weight, such as 1.5% by to 5% by weight, such as 1.5% to 4% by weight, such as 1.5% to 3% by weight, such as 1.5% to 2% by weight, based on the total weight of polymerizable monomers used in the reaction mixture. The inclusion of constitutional units comprising the residue of a hydroxyalkyl ester in the (meth)acrylic polymer results in an (meth)acrylic polymer comprising at least one hydroxyl group (although hydroxyl groups may be included by other methods). Hydroxyl groups resulting from inclusion of the hydroxyalkyl esters (or incorporated by other means) may react with a separately added crosslinking agent that comprises functional groups reactive with hydroxyl groups such as, for example, an aminoplast, phenolplast, and polyepoxides, or with N-alkoxymethyl amide groups present in the (meth)acrylic polymer when self-crosslinking monomers that have groups that are reactive with the hydroxyl groups are incorporated into the (meth)acrylic polymer.

The (meth)acrylic polymer may optionally comprise constitutional units comprising the residue of an alpha, beta-ethylenically unsaturated carboxylic acid. Non-limiting examples of alpha, beta-ethylenically unsaturated carboxylic acids include those containing up to 10 carbon atoms such as acrylic acid and methacrylic acid. Non-limiting examples of other unsaturated acids are alpha, beta-ethylenically unsaturated dicarboxylic acids such as maleic acid or its anhydride, fumaric acid and itaconic acid. Also, the half esters of these dicarboxylic acids may be employed. If present, the constitutional units comprising the residue of the alpha, beta-ethylenically unsaturated carboxylic acids may comprise at least 0.5% by weight, such as at least 1% by weight, such as at least 1.5% by weight, based on the total weight of the (meth)acrylic polymer. If present, the constitutional units comprising the residue of the alpha, beta-ethylenically unsaturated carboxylic acids may comprise no more than 10% by weight, such as no more than 8% by weight, such as no more than 6% by weight, such as no more than 5% by weight, such as no more than 4% by weight, such as no more than 3% by weight, such as no more than 2% by weight, such as no more than 1.5% by weight, such as no more than 1.0% by weight, based on the total weight of the (meth)acrylic polymer. The constitutional units comprising the residue of the alpha, beta-ethylenically unsaturated carboxylic acids may comprise 0.5% to 10% by weight, such as 0.5% to 8% by weight, such as 0.5% to 6% by weight, such as 0.5% by to 5% by weight, such as 0.5% to 4% by weight, such as 0.5% to 3% by weight, such as 0.5% to 2% by weight, such as 0.5% to 1.5% by weight, such as 0.5% to 1.0% by weight, such as 1% to 10% by weight, such as 1% to 8% by weight, such as 1% to 6% by weight, such as 1% by to 5% by weight, such as 1% to 4% by weight, such as 1% to 3% by weight, such as 1% to 2% by weight, such as 1% to 1.5% by weight, such as 1.5% to 10% by weight, such as 1.5% to 8% by weight, such as 1.5% to 6% by weight, such as 1.5% by to 5% by weight, such as 1.5% to 4% by weight, such as 1.5% to 3% by weight, such as 1.5% to 2% by weight, based on the total weight of the (meth)acrylic polymer. The (meth)acrylic polymer may be derived from a reaction mixture comprising the alpha, beta-ethylenically unsaturated carboxylic acids in an amount of 0.5% to 10% by weight, such as 0.5% to 8% by weight, such as 0.5% to 6% by weight, such as 0.5% by to 5% by weight, such as 0.5% to 4% by weight, such as 0.5% to 3% by weight, such as 0.5% to 2% by weight, such as 0.5% to 1.5% by weight, such as 0.5% to 1.0% by weight, such as 1% to 10% by weight, such as 1% to 8% by weight, such as 1% to 6% by weight, such as 1% by to 5% by weight, such as 1% to 4% by weight, such as 1% to 3% by weight, such as 1% to 2% by weight, such as 1% to 1.5% by weight, such as 1.5% to 10% by weight, such as 1.5% to 8% by weight, such as 1.5% to 6% by weight, such as 1.5% by to 5% by weight, such as 1.5% to 4% by weight, such as 1.5% to 3% by weight, such as 1.5% to 2% by weight, based on the total weight of polymerizable monomers used in the reaction mixture. The inclusion of constitutional units comprising the residue of an alpha, beta-ethylenically unsaturated carboxylic acids in the (meth)acrylic polymer results in an (meth)acrylic polymer comprising at least one carboxylic acid group.

The (meth)acrylic polymer optionally may comprise constitutional units comprising the residue of an ethylenically unsaturated monomer comprising a heterocyclic group. Non-limiting examples of ethylenically unsaturated monomers comprising a heterocyclic group include epoxy functional ethylenically unsaturated monomers (e.g., glycidyl (meth)acrylate), vinyl pyrrolidone and vinyl caprolactam, among others. The constitutional units comprising the residue of the ethylenically unsaturated monomers comprising a heterocyclic group may, if present, comprise at least 0.5% by weight, such as at least 1% by weight, such as at least 2% by weight, such as at least 3% by weight, such as at least 4% by weight, such as at least 5% by weight, such as at least 8% by weight, based on the total weight of the (meth)acrylic polymer. The constitutional units comprising the residue of the ethylenically unsaturated monomers comprising a heterocyclic group may, if present, comprise no more than 20% by weight, such as no more than 15% by weight, such as no more than 10% by weight, such as no more than 5% by weight, based on the total weight of the (meth)acrylic polymer. The constitutional units comprising the residue of the ethylenically unsaturated monomers comprising a heterocyclic group may comprise 0% to 20% by weight, such as 0.5% to 20% by weight, such as 0.5% to 15% by weight, such as 0.5% to 10% by weight, such as 0.5% to 5% by weight, such as 1% to 20% by weight, such as 1% to 15% by weight, such as 1% to 10% by weight, such as 1% to 5% by weight, such as 2% to 20% by weight, such as 2% to 15% by weight, such as 2% to 10% by weight, such as 2% to 5% by weight, such as 3% to 20% by weight, such as 3% to 15% by weight, such as 3% to 10% by weight, such as 3% to 5% by weight, such as 4% to 20% by weight, such as 4% to 15% by weight, such as 4% to 10% by weight, such as 4% to 5% by weight, such as 5% to 20% by weight, such as 5% to 15% by weight, such as 5% to 10% by weight, such as 8% to 20% by weight, such as 8% to 15% by weight, such as 8% to 10% by weight, based on the total weight of the (meth)acrylic polymer. The (meth)acrylic polymer may be derived from a reaction mixture comprising the ethylenically unsaturated monomers comprising a heterocyclic group in an amount of such as 0.5% to 20% by weight, such as 0.5% to 15% by weight, such as 0.5% to 10% by weight, such as 0.5% to 5% by weight, such as 1% to 20% by weight, such as 1% to 15% by weight, such as 1% to 10% by weight, such as 1% to 5% by weight, such as 2% to 20% by weight, such as 2% to 15% by weight, such as 2% to 10% by weight, such as 2% to 5% by weight, such as 3% to 20% by weight, such as 3% to 15% by weight, such as 3% to 10% by weight, such as 3% to 5% by weight, such as 4% to 20% by weight, such as 4% to 15% by weight, such as 4% to 10% by weight, such as 4% to 5% by weight, such as 5% to 20% by weight, such as 5% to 15% by weight, such as 5% to 10% by weight, such as 8% to 20% by weight, such as 8% to 15% by weight, such as 8% to 10% by weight, based on the total weight of polymerizable monomers used in the reaction mixture.

As noted above, the (meth)acrylic polymer may optionally comprise constitutional units comprising the residue of a self-crosslinking monomer, and the (meth)acrylic polymer may comprise a self-crosslinking (meth)acrylic polymer. As used herein, the term “self-crosslinking monomer” refers to monomers that incorporate functional groups that may react with active hydrogen functional groups present on the (meth)acrylic polymer to form a crosslink between the (meth)acrylic polymer or more than one (meth)acrylic polymer, and the term “self-crosslinking monomer” expressly excludes monomers having silicon-containing groups. Non-limiting examples of self-crosslinking monomers include N-alkoxymethyl (meth)acrylamide monomers such as N-butoxymethyl (meth)acrylamide and N-isopropoxymethyl (meth)acrylamide. The constitutional units comprising the residue of the self-crosslinking monomer may comprise at least 0.5% by weight, such as at least 1% by weight, such as at least 1.5% by weight, based on the total weight of the (meth)acrylic polymer. The constitutional units comprising the residue of the self-crosslinking monomer may comprise no more than 20% by weight, such as no more than 15% by weight, such as no more than 8% by weight, such as no more than 6% by weight, such as no more than 5% by weight, such as no more than 4% by weight, such as no more than 3% by weight, such as no more than 2% by weight, such as no more than 1.5% by weight, such as no more than 1.0% by weight, based on the total weight of the (meth)acrylic polymer. The constitutional units comprising the residue of the self-crosslinking monomer may comprise 0.5% to 20% by weight, such as 0.5% to 15% by weight, such as 0.5% to 10% by weight, such as 0.5% to 8% by weight, such as 0.5% to 6% by weight, such as 0.5% by to 5% by weight, such as 0.5% to 4% by weight, such as 0.5% to 3% by weight, such as 0.5% to 2% by weight, such as 0.5% to 1.5% by weight, such as 0.5% to 1.0% by weight, such as 1% to 20% by weight, such as 1% to 15% by weight, such as 1% to 10% by weight, such as 1% to 8% by weight, such as 1% to 6% by weight, such as 1% by to 5% by weight, such as 1% to 4% by weight, such as 1% to 3% by weight, such as 1% to 2% by weight, such as 1% to 1.5% by weight, such as 1.5% to 20% by weight, such as 1.5% to 15% by weight, such as 1.5% to 10% by weight, such as 1.5% to 8% by weight, such as 1.5% to 6% by weight, such as 1.5% by to 5% by weight, such as 1.5% to 4% by weight, such as 1.5% to 3% by weight, such as 1.5% to 2% by weight, based on the total weight of the (meth)acrylic polymer. The (meth)acrylic polymer may be derived from a reaction mixture comprising the self-crosslinking monomer in an amount of 0.5% to 20% by weight, such as 0.5% to 15% by weight, such as 0.5% to 10% by weight, such as 0.5% to 8% by weight, such as 0.5% to 6% by weight, such as 0.5% by to 5% by weight, such as 0.5% to 4% by weight, such as 0.5% to 3% by weight, such as 0.5% to 2% by weight, such as 0.5% to 1.5% by weight, such as 0.5% to 1.0% by weight, such as 1% to 20% by weight, such as 1% to 15% by weight, such as 1% to 10% by weight, such as 1% to 8% by weight, such as 1% to 6% by weight, such as 1% by to 5% by weight, such as 1% to 4% by weight, such as 1% to 3% by weight, such as 1% to 2% by weight, such as 1% to 1.5% by weight, such as 1.5% to 20% by weight, such as 1.5% to 15% by weight, such as 1.5% to 10% by weight, such as 1.5% to 8% by weight, such as 1.5% to 6% by weight, such as 1.5% by to 5% by weight, such as 1.5% to 4% by weight, such as 1.5% to 3% by weight, such as 1.5% to 2% by weight, based on the total weight of polymerizable monomers used in the reaction mixture.

The (meth)acrylic polymer may optionally comprise constitutional units comprising the residue of a vinyl aromatic compound. Non-limiting examples of vinyl aromatic compounds includes styrene, alpha-methyl styrene, alpha-chlorostyrene and vinyl toluene. The constitutional units comprising the residue of the vinyl aromatic compound may comprise at least 1% by weight, such as at least 5% by weight, such as at least 10% by weight, such as at least 15% by weight, such as at least 20% by weight, such as at least 25% by weight, based on the total weight of the (meth)acrylic polymer. The constitutional units comprising the residue of the vinyl aromatic compound may comprise no more than 80% by weight, such as no more than 65% by weight, such as no more than 50% by weight, such as no more than 40% by weight, such as no more than 30% by weight, such as no more than 20% by weight, such as no more than 15% by weight, such as no more than 10% by weight, based on the total weight of the (meth)acrylic polymer. The constitutional units comprising the residue of the vinyl aromatic compound may comprise 1% to 80% by weight, such as 1% to 65% by weight, such as 1% to 50% by weight, such as 1% to 40% by weight, such as 1% to 30% by weight, such as 1% to 20% by weight, such as 1% to 15% by weight, such as 1% to 10% by weight, such as 5% to 80% by weight, such as 5% to 65% by weight, such as 5% to 50% by weight, such as 5% to 40% by weight, such as 5% to 30% by weight, such as 5% to 20% by weight, such as 5% to 15% by weight, such as 5% to 10% by weight, such as 10% to 80% by weight, such as 10% to 65% by weight, such as 10% to 50% by weight, such as 10% to 40% by weight, such as 10% to 30% by weight, such as 10% to 20% by weight, such as 10% to 15% by weight, such as 15% to 80% by weight, such as 15% to 65% by weight, such as 15% to 50% by weight, such as 15% to 40% by weight, such as 15% to 30% by weight, such as 15% to 20% by weight, such as 20% to 80% by weight, such as 20% to 65% by weight, such as 20% to 50% by weight, such as 20% to 40% by weight, such as 20% to 30% by weight, such as 25% to 80% by weight, such as 25% to 65% by weight, such as 25% to 50% by weight, such as 25% to 40% by weight, such as 25% to 30% by weight, based on the total weight of the (meth)acrylic polymer. The (meth)acrylic polymer may be derived from a reaction mixture comprising the vinyl aromatic compound in an amount of such as 1% to 80% by weight, such as 1% to 65% by weight, such as 1% to 50% by weight, such as 1% to 40% by weight, such as 1% to 30% by weight, such as 1% to 20% by weight, such as 1% to 15% by weight, such as 1% to 10% by weight, such as 5% to 80% by weight, such as 5% to 65% by weight, such as 5% to 50% by weight, such as 5% to 40% by weight, such as 5% to 30% by weight, such as 5% to 20% by weight, such as 5% to 15% by weight, such as 5% to 10% by weight, such as 10% to 80% by weight, such as 10% to 65% by weight, such as 10% to 50% by weight, such as 10% to 40% by weight, such as 10% to 30% by weight, such as 10% to 20% by weight, such as 10% to 15% by weight, such as 15% to 80% by weight, such as 15% to 65% by weight, such as 15% to 50% by weight, such as 15% to 40% by weight, such as 15% to 30% by weight, such as 15% to 20% by weight, such as 20% to 80% by weight, such as 20% to 65% by weight, such as 20% to 50% by weight, such as 20% to 40% by weight, such as 20% to 30% by weight, such as 25% to 80% by weight, such as 25% to 65% by weight, such as 25% to 50% by weight, such as 25% to 40% by weight, such as 25% to 30% by weight, based on the total weight of polymerizable monomers used in the reaction mixture.

The (meth)acrylic polymer may optionally comprise constitutional units comprising the residue of a vinyl ester monomer. As used herein, a “vinyl ester” monomer refers to a compound having the structure C═C—O—C(O)—R, wherein R is an alkyl group having 1 to 5 carbon atoms. Non-limiting examples of vinyl ester monomers include vinyl acetate, vinyl propionate, and the like. The constitutional units comprising the residue of the vinyl ester monomer may comprise at least 1% by weight, such as at least 5% by weight, such as at least 10% by weight, such as at least 15% by weight, such as at least 20% by weight, such as at least 25% by weight, based on the total weight of the (meth)acrylic polymer. The constitutional units comprising the residue of the vinyl ester monomer may comprise no more than 80% by weight, such as no more than 65% by weight, such as no more than 50% by weight, such as no more than 40% by weight, such as no more than 30% by weight, such as no more than 20% by weight, such as no more than 15% by weight, such as no more than 10% by weight, based on the total weight of the (meth)acrylic polymer. The constitutional units comprising the residue of the vinyl ester monomer may comprise 1% to 80% by weight, such as 1% to 65% by weight, such as 1% to 50% by weight, such as 1% to 40% by weight, such as 1% to 30% by weight, such as 1% to 20% by weight, such as 1% to 15% by weight, such as 1% to 10% by weight, such as 5% to 80% by weight, such as 5% to 65% by weight, such as 5% to 50% by weight, such as 5% to 40% by weight, such as 5% to 30% by weight, such as 5% to 20% by weight, such as 5% to 15% by weight, such as 5% to 10% by weight, such as 10% to 80% by weight, such as 10% to 65% by weight, such as 10% to 50% by weight, such as 10% to 40% by weight, such as 10% to 30% by weight, such as 10% to 20% by weight, such as 10% to 15% by weight, such as 15% to 80% by weight, such as 15% to 65% by weight, such as 15% to 50% by weight, such as 15% to 40% by weight, such as 15% to 30% by weight, such as 15% to 20% by weight, such as 20% to 80% by weight, such as 20% to 65% by weight, such as 20% to 50% by weight, such as 20% to 40% by weight, such as 20% to 30% by weight, such as 25% to 80% by weight, such as 25% to 65% by weight, such as 25% to 50% by weight, such as 25% to 40% by weight, such as 25% to 30% by weight, based on the total weight of the (meth)acrylic polymer. The (meth)acrylic polymer may be derived from a reaction mixture comprising the vinyl ester monomer in an amount of such as 1% to 80% by weight, such as 1% to 65% by weight, such as 1% to 50% by weight, such as 1% to 40% by weight, such as 1% to 30% by weight, such as 1% to 20% by weight, such as 1% to 15% by weight, such as 1% to 10% by weight, such as 5% to 80% by weight, such as 5% to 65% by weight, such as 5% to 50% by weight, such as 5% to 40% by weight, such as 5% to 30% by weight, such as 5% to 20% by weight, such as 5% to 15% by weight, such as 5% to 10% by weight, such as 10% to 80% by weight, such as 10% to 65% by weight, such as 10% to 50% by weight, such as 10% to 40% by weight, such as 10% to 30% by weight, such as 10% to 20% by weight, such as 10% to 15% by weight, such as 15% to 80% by weight, such as 15% to 65% by weight, such as 15% to 50% by weight, such as 15% to 40% by weight, such as 15% to 30% by weight, such as 15% to 20% by weight, such as 20% to 80% by weight, such as 20% to 65% by weight, such as 20% to 50% by weight, such as 20% to 40% by weight, such as 20% to 30% by weight, such as 25% to 80% by weight, such as 25% to 65% by weight, such as 25% to 50% by weight, such as 25% to 40% by weight, such as 25% to 30% by weight, based on the total weight of polymerizable monomers used in the reaction mixture.

The (meth)acrylic polymer may optionally comprise constitutional units comprising the residue of other alpha, beta-ethylenically unsaturated monomers. Non-limiting examples of other alpha, beta-ethylenically unsaturated monomers include organic nitriles such as acrylonitrile and methacrylonitrile; allyl monomers such as allyl chloride and allyl cyanide; monomeric dienes such as 1,3-butadiene and 2-methyl-1,3-butadiene; and acetoacetoxyalkyl (meth)acrylates such as acetoacetoxyethyl methacrylate (AAEM) (which may be self-crosslinking). The constitutional units comprising the residue of the other alpha, beta-ethylenically unsaturated monomers may comprise at least at least 0.5% by weight, such as at least 1% by weight, such as at least 1.5% by weight, based on the total weight of the (meth)acrylic polymer. The constitutional units comprising the residue of the other alpha, beta-ethylenically unsaturated monomers may comprise no more than 20% by weight, such as no more than 15% by weight, such as no more than 8% by weight, such as no more than 6% by weight, such as no more than 5% by weight, such as no more than 4% by weight, such as no more than 3% by weight, such as no more than 2% by weight, such as no more than 1.5% by weight, such as no more than 1.0% by weight, based on the total weight of the (meth)acrylic polymer. The constitutional units comprising the residue of the other alpha, beta-ethylenically unsaturated monomers may comprise 0.5% to 20% by weight, such as 0.5% to 15% by weight, such as 0.5% to 10% by weight, such as 0.5% to 8% by weight, such as 0.5% to 6% by weight, such as 0.5% by to 5% by weight, such as 0.5% to 4% by weight, such as 0.5% to 3% by weight, such as 0.5% to 2% by weight, such as 0.5% to 1.5% by weight, such as 0.5% to 1.0% by weight, such as 1% to 20% by weight, such as 1% to 15% by weight, such as 1% to 10% by weight, such as 1% to 8% by weight, such as 1% to 6% by weight, such as 1% by to 5% by weight, such as 1% to 4% by weight, such as 1% to 3% by weight, such as 1% to 2% by weight, such as 1% to 1.5% by weight, such as 1.5% to 20% by weight, such as 1.5% to 15% by weight, such as 1.5% to 10% by weight, such as 1.5% to 8% by weight, such as 1.5% to 6% by weight, such as 1.5% by to 5% by weight, such as 1.5% to 4% by weight, such as 1.5% to 3% by weight, such as 1.5% to 2% by weight, based on the total weight of the (meth)acrylic polymer. The (meth)acrylic polymer may be derived from a reaction mixture comprising the other alpha, beta-ethylenically unsaturated monomers in an amount of 0.5% to 20% by weight, such as 0.5% to 15% by weight, such as 0.5% to 10% by weight, such as 0.5% to 8% by weight, such as 0.5% to 6% by weight, such as 0.5% by to 5% by weight, such as 0.5% to 4% by weight, such as 0.5% to 3% by weight, such as 0.5% to 2% by weight, such as 0.5% to 1.5% by weight, such as 0.5% to 1.0% by weight, such as 1% to 20% by weight, such as 1% to 15% by weight, such as 1% to 10% by weight, such as 1% to 8% by weight, such as 1% to 6% by weight, such as 1% by to 5% by weight, such as 1% to 4% by weight, such as 1% to 3% by weight, such as 1% to 2% by weight, such as 1% to 1.5% by weight, such as 1.5% to 20% by weight, such as 1.5% to 15% by weight, such as 1.5% to 10% by weight, such as 1.5% to 8% by weight, such as 1.5% to 6% by weight, such as 1.5% by to 5% by weight, such as 1.5% to 4% by weight, such as 1.5% to 3% by weight, such as 1.5% to 2% by weight, based on the total weight of polymerizable monomers used in the reaction mixture.

The (meth)acrylic polymer may comprise functional groups. The functional groups may comprise, for example, active hydrogen functional groups, heterocyclic groups, silicon-containing functional groups, and any combination thereof, and the functional groups may be incorporated through the use of the monomers discussed above as well as any other functionalized ethylenically unsaturated monomer or post-reacted compound. In addition, when epoxide functional groups are present on the (meth)acrylic polymer, the epoxide functional groups on the (meth)acrylic polymer optionally may be post-reacted with an acid, such as a beta-hydroxy functional acid. Non-limiting examples of beta-hydroxy functional acids include citric acid, tartaric acid, and/or an aromatic acid, such as 3-hydroxy-2-naphthoic acid. The ring opening reaction of the epoxide functional group will yield hydroxyl functional groups on the (meth)acrylic.

The monomers and relative amounts may be selected such that the resulting (meth)acrylic polymer has a Tg of 100° C. or less. The resulting (meth)acrylic polymer may have a Tg of, for example, at least −50° C., such as at least −40° C., such as −30° C., such as, −20° C., such as −15° C., such as −10° C., such as −5° C., such as 0° C. The resulting (meth)acrylic polymer may have a Tg of, for example, no more than +70° C., such as no more than +60° C., such as no more than +50° C., such as no more than +40° C., such as no more than +25° C., such as no more than +15° C., such as no more than +10° C., such as no more than +5° C., such as no more than 0° C. The resulting (meth)acrylic polymer may have a Tg of, for example, −50 to +70° C., such as −50 to +60° C., such as −50 to +50° C., such as −50 to +40° C., such as −50 to +25° C., such as −50 to +20° C., such as −50 to +15° C., such as −50 to +10° C., such as −50 to +5° C., such as −50 to 0° C., such as −40 to +50° C., such as −40 to +40° C., such as −40 to +25° C., such as −40 to +20° C., such as −40 to +15° C., such as −40 to +10° C., such as −40 to +5° C., such as −40 to 0° C., such as −30 to +50° C. such as −30 to +40° C., such as −30 to +25° C., such as −30 to +20° C., such as −30 to +15° C., such as −30 to +10° C., such as −30 to +5° C., such as −30 to 0° C., such as −20 to +50° C., such as −20 to +40° C., such as −20 to +25° C., such as −20 to +20° C., such as −20 to +15° C., such as −20 to +10° C., such as −20 to +5° C., such as −20 to 0° C., such as −15 to +50° C., such as −15 to +40° C., such as −15 to +25° C., such as −15 to +20° C., such as −15 to +15° C., such as −15 to +10° C., such as −15 to +5° C., such as −15 to 0° C., such as −10 to +50° C., such as −10 to +40° C., such as −10 to +25° C., such as −10 to +20° C., such as −10 to +15° C., such as −10 to +10° C., such as −10 to +5° C., such as −10 to 0° C., such as −5 to +50° C., such as −5 to +40° C., such as −5 to +25° C., such as −5 to +20° C., such as −5 to +15° C., such as −5 to +10° C., such as −5 to +5° C., such as −5 to 0° C., such as 0 to +50° C., such as 0 to +40° C., such as 0 to +25° C., such as 0 to +20° C., such as 0 to +15° C. A lower Tg that is below 0° C. may be desirable to ensure acceptable battery performance at low temperature.

The (meth)acrylic polymer may have a number average molecular weight of at least 1,000 g/mol, such as at least 1,500 g/mol, such as at least 2,500 g/mol, such as at least 5,000 g/mol, such as at least 7,500 g/mol, such at least 10,000 g/mol. The (meth)acrylic polymer may have a number average molecular weight of no more than 100,000 g/mol, such as no more than 75,000 g/mol, such as no more than 50,000 g/mol, such as no more than 25,000 g/mol, such as no more than 20,000 g/mol, such as no more than 15,000 g/mol, such as no more than 10,000 g/mol, such as no more than 7,500 g/mol. The (meth)acrylic polymer may have a number average molecular weight of 1,000 to 100,000 g/mol, such as 1,000 to 75,000 g/mol, such as 1,000 to 50,000 g/mol, such as 1,000 to 25,000 g/mol, such as 1,000 to 20,000 g/mol, such as 1,000 to 15,000 g/mol, such as 1,000 to 12,500 g/mol, such as 1,000 to 10,000 g/mol, such as 1,000 to 7,500 g/mol, such as 1,500 to 100,000 g/mol, such as 1,500 to 75,000 g/mol, such as 1,500 to 50,000 g/mol, such as 1,500 to 25,000 g/mol, such as 1,500 to 20,000 g/mol, such as 1,500 to 15,000 g/mol, such as 1,500 to 12,500 g/mol, such as 1,500 to 10,000 g/mol, such as 1,500 to 7,500 g/mol, such as 2,500 to 100,000 g/mol, such as 2,500 to 75,000 g/mol, such as 2,500 to 50,000 g/mol, such as 2,500 to 25,000 g/mol, such as 2,500 to 20,000 g/mol, such as 2,500 to 15,000 g/mol, such as 2,500 to 12,500 g/mol, such as 2,500 to 10,000 g/mol, such as 2,500 to 7,500 g/mol, 5,000 to 100,000 g/mol, such as 5,000 to 75,000 g/mol, such as 5,000 to 50,000 g/mol, such as 5,000 to 25,000 g/mol, such as 5,000 to 20,000 g/mol, such as 5,000 to 15,000 g/mol, such as 5,000 to 12,500 g/mol, such as 5,000 to 10,000 g/mol, such as 5,000 to 7,500 g/mol, 7,500 to 100,000 g/mol, such as 7,500 to 75,000 g/mol, such as 7,500 to 50,000 g/mol, such as 7,500 to 25,000 g/mol, such as 7,500 to 20,000 g/mol, such as 7,500 to 15,000 g/mol, such as 7,500 to 12,500 g/mol, such as 7,500 to 10,000 g/mol, 10,000 to 100,000 g/mol, such as 10,000 to 75,000 g/mol, such as 10,000 to 50,000 g/mol, such as 10,000 to 25,000 g/mol, such as 10,000 to 20,000 g/mol, such as 10,000 to 15,000 g/mol, such as 10,000 to 12,500 g/mol.

The (meth)acrylic polymer may have a weight average molecular weight of at least at least 2,000 g/mol, such as at least 5,000 g/mol, such as at least 10,000 g/mol, such as at least 15,000 g/mol, such at least 20,000 g/mol. The (meth)acrylic polymer may have a weight average molecular weight of no more than 1,000,000 g/mol, such as no more than 500,000 g/mol, such as no more than 200,000 g/mol, such as no more than 150,000 g/mol, such as no more than 100,000 g/mol, such as no more than 50,000 g/mol, such as no more than 40,000 g/mol, such as no more than 30,000 g/mol, such as no more than 20,000 g/mol, such as no more than 15,000 g/mol. The (meth)acrylic polymer may have a weight average molecular weight of 2,000 to 1,000,000 g/mol, such as 2,000 to 500,000 g/mol, such as 2,000 to 200,000 g/mol, such as 2,000 to 150,000 g/mol, such as 2,000 to 100,000 g/mol, such as 2,000 to 50,000 g/mol, such as 2,000 to 40,000 g/mol, such as 2,000 to 30,000 g/mol, such as 2,000 to 25,000 g/mol, such as 2,000 to 20,000 g/mol, such as 2,000 to 15,000 g/mol, such as 5,000 to 1,000,000 g/mol, such as 5,000 to 500,000 g/mol, such as 5,000 to 200,000 g/mol, such as 5,000 to 150,000 g/mol, such as 5,000 to 100,000 g/mol, such as 5,000 to 50,000 g/mol, such as 5,000 to 40,000 g/mol, such as 5,000 to 30,000 g/mol, such as 5,000 to 25,000 g/mol, such as 5,000 to 20,000 g/mol, such as 5,000 to 15,000 g/mol, such as 10,000 to 1,000,000 g/mol, such as 10,000 to 500,000 g/mol, such as 10,000 to 200,000 g/mol, such as 10,000 to 150,000 g/mol, such as 10,000 to 100,000 g/mol, such as 10,000 to 50,000 g/mol, such as 10,000 to 40,000 g/mol, such as 10,000 to 30,000 g/mol, such as 10,000 to 25,000 g/mol, such as 10,000 to 20,000 g/mol, such as 10,000 to 15,000 g/mol, such as 15,000 to 1,000,000 g/mol, such as 15,000 to 500,000 g/mol, such as 15,000 to 200,000 g/mol, such as 15,000 to 150,000 g/mol, such as 15,000 to 100,000 g/mol, such as 15,000 to 50,000 g/mol, such as 15,000 to 40,000 g/mol, such as 15,000 to 30,000 g/mol, such as 15,000 to 25,000 g/mol, such as 15,000 to 20,000 g/mol, such as 20,000 to 200,000 g/mol, such as 20,000 to 150,000 g/mol, such as 20,000 to 100,000 g/mol, such as 20,000 to 50,000 g/mol, such as 20,000 to 40,000 g/mol, such as 20,000 to 30,000 g/mol, such as 20,000 to 25,000 g/mol.

The (meth)acrylic polymer may be prepared by conventional free radical initiated solution polymerization techniques in which the polymerizable monomers are dissolved in an organic medium comprising a solvent or a mixture of solvents and polymerized in the presence of a free radical initiator until conversion is complete, as discussed above with respect to the addition polymer.

The (meth)acrylic polymer may be present in the binder in amounts of at least 0.1% by weight, such as at least 1% by weight, such as at least 2% by weight, such as at least 3% by weight, such as at least 4% by weight, such as at least 5% by weight, based on the total weight of the binder solids. The (meth)acrylic polymer may be present in the binder in amounts of no more than 25% by weight, such as no more than 20% by weight, such as no more than 15% by weight, such as no more than 12.5% by weight, such as no more than 10% by weight, such as no more than 5% by weight, based on the total weight of the binder solids. The (meth)acrylic polymer may be present in the binder in amounts of 0.1% to 25% by weight, such as 0.1% to 20% by weight, such as 0.1% to 15% by weight, such as 0.1% to 12.5% by weight, such as 0.1% to 10% by weight, such as 0.1% to 5% by weight, such as 1% to 25% by weight, such as 1% to 20% by weight, such as 1% to 15% by weight, such as 1% to 12.5% by weight, such as 1% to 10% by weight, such as 1% to 5% by weight, such as 2% to 25% by weight, such as 2% to 20% by weight, such as 2% to 15% by weight, such as 2% to 12.5% by weight, such as 2% to 10% by weight, such as 2% to 5% by weight, such as 3% to 25% by weight, such as 3% to 20% by weight, such as 3% to 15% by weight, such as 3% to 12.5% by weight, such as 3% to 10% by weight, such as 3% to 5% by weight, such as 4% to 25% by weight, such as 4% to 20% by weight, such as 4% to 15% by weight, such as 4% to 12.5% by weight, such as 4% to 10% by weight, such as 4% to 5% by weight, such as 5% to 25% by weight, such as 5% to 20% by weight, such as 5% to 15% by weight, such as 5% to 12.5% by weight, such as 5% to 10% by weight, based on the total weight of the binder solids.

The (meth)acrylic polymer may be present in the slurry composition in an amount of at least 0.1% by weight, such as at least 1% by weight, such as at least 1.3% by weight, such as at least 1.5% by weight, such as at least 1.9% by weight, based on the total solids weight of the slurry composition. The (meth)acrylic polymer may be present in the slurry composition in an amount of no more than 10% by weight, such as no more than 6% by weight, such as no more than 4.5% by weight, such as no more than 2.9% by weight, such as no more than 2.5% by weight, such as no more than 2% by weight, based on the total solids weight of the slurry composition. The (meth)acrylic polymer may be present in the slurry composition in an amount of 0.1% to 10% by weight, such as 0.1% to 6% by weight, such as 0.1% to 4.5% by weight, such as 0.1% to 2.9% by weight, such as 0.1% to 2.5% by weight, such as 0.1% to 2% by weight, such as 1% to 10% by weight, such as 1% to 6% by weight, such as 1% to 4.5% by weight, such as 1% to 2.9% by weight, such as 1% to 2.5% by weight, such as 1% to 2% by weight, such as 1.3% to 10% by weight, such as 1.3% to 6% by weight, such as 1.3% to 4.5% by weight, such as 1.3% to 2.9% by weight, such as 1.3% to 2.5% by weight, such as 1.3% to 2% by weight, such as 1.5% to 10% by weight, such as 1.5% to 6% by weight, such as 1.5% to 4.5% by weight, such as 1.5% to 2.9% by weight, such as 1.5% to 2.5% by weight, such as 1.5% to 2% by weight, such as 1.9% to 10% by weight, such as 1.9% to 6% by weight, such as 1.9% to 4.5% by weight, such as 1.9% to 2.9% by weight, such as 1.9% to 2.5% by weight, such as 1.9% to 2% by weight, such as 1% to 10% by weight, such as 1% to 6% by weight, such as 1% to 4.5% by weight, such as 1% to 2.9% by weight, such as 1% to 2.5% by weight, such as 1% to 2% by weight, based on the total solids weight of the slurry composition.

According to the present disclosure, the binder composition and/or slurry composition of the present disclosure further comprises a liquid medium.

The fluoropolymer of the binder composition and/or slurry composition may be solubilized or dispersed in the liquid medium at room temperature, i.e., about 23° C., and ambient pressure (about 1 atm).

The liquid medium of the binder composition and/or slurry composition may comprise an organic medium. As used herein, the term “organic medium” refers to a liquid medium comprising less than 50% by weight water, based on the total weight of the organic medium. Such organic mediums may comprise less than 45% by weight water, such as less than 40% by weight water, such as less than 45% by weight water, such as less than 30% by weight water, such as less than 25% by weight water, such as less than 20% by weight water, such as less than 15% by weigh water, such as less than 10% by weight water, such as less than 5% by weight water, such as less than 2.5% by weight water, such as less than 1% by weight water, such as less than 0.1% by weight water, based on the total weight of the organic medium. Alternatively, the organic medium may be free of water, i.e., 0.00% by weight water. Organic solvent(s) comprise more than 50% by weight of the organic medium, such as at least 70% by weight, such as at least 80% by weight, such as at least 90% by weight, such as at least 95% by weight, such as at least 99% by weight, such as at least 99.9% by weight, such as 100% by weight, based on the total weight of the organic medium. The organic solvent(s) may comprise 50.1% to 100% by weight, such as 70% to 100% by weight, such as 80% to 100% by weight, such as 90% to 100% by weight, such as 95% to 100% by weight, such as 99% to 100% by weight, such as 99.9% to 100% by weight, based on the total weight of the organic medium.

The organic medium may comprise, consist essentially of, or consist of, for example, ketones such as methyl ethyl ketone, cyclohexanone and isophorone, ethers such as the C₁ to C₄ alkyl ethers of ethylene and propylene glycol, butyl pyrrolidone, trialkyl phosphate, 1,2,3-triacetoxypropane, 3-methoxy-N,N-dimethylpropanamide, ethyl acetoacetate, gamma-butyrolactone, propylene glycol methyl ether, propylene carbonate, dimethyl adipate, propylene glycol methyl ether acetate, dibasic ester (DBE), dibasic ester 5 (DBE-5), 4-hydroxy-4-methyl-2-pentanone (diacetone alcohol), propylene glycol diacetate, dimethyl phthalate, methyl isoamyl ketone, ethyl propionate, 1-ethoxy-2-propanol, dipropylene glycol dimethyl ether, saturated and unsaturated linear and cyclic ketones (commercially available as a mixture thereof as Eastman™ C-11 Ketone from Eastman Chemical Company), diisobutyl ketone, acetate esters (commercially available as Exxate™ 1000 from Hallstar), tripropylene glycol methyl ether, diethylene glycol ethyl ether acetate, or combinations thereof. The trialkyl phosphate may comprise, for example, trimethylphosphate, tricthylphosphate, tripropylphosphate, tributylphosphate, or the like.

As discussed above, when the fluoropolymer is dispersed in the organic medium at room temperature and pressure, the organic medium may have an evaporation rate less than 10 g/min m², at the dissolution temperature of the fluoropolymer dispersed in the organic medium. Evaporation rates may be measured using ASTM D3539 (1996). The dissolution temperature of the fluoropolymer dispersed in the organic medium may be determined by measuring complex viscosity of the mixture as a function of temperature. This technique may be applied to fluoropolymers (in addition to other types of polymer) mixed in an organic medium where the total mass of non-volatile solids content of such mixtures is from 44% to 46%, such as 45% of the total mass of the mixture. Complex viscosity may be measured with an Anton-Paar MCR301 rheometer using a 50-millimeter cone and temperature-controlled plate. The complex viscosity of fluoropolymer mixtures is measured over a temperature range from 35° C. to at least 75° C. with a temperature ramp rate of 10° C. per minute, an oscillatory frequency of 1 Hz, and a stress amplitude limit of 90 Pa. The dissolution of fluoropolymer in the organic medium is indicated by a sharp increase in the complex viscosity as temperature increased. The dissolution temperature is defined as the temperature at which the rate of change in viscosity with ramping temperature is highest and is calculated by determining the temperature at which the first derivative with respect to temperature of the Log₁₀ of the complex viscosity reaches a maximum. The table below illustrates dissolution temperatures determined according to this method using PVDF T-1 from Inner Mongolia 3F Wanhao Fluorochemical Co. Ltd. (PVDF T-1 has a particle size of about 330 to 380 nm and a weight average molecular weight of about 130,000 to 160,000 g/mol), in various solvents or solvent mixtures as listed.

| | Solvent | | Cosolvent | | | Evaporation |
|---|---|---|---|---|---|---|
| | % mass of | | % mass of | PVDF % | | rate at |
| | organic | | organic | mass of | Dissolution | Dissolution |
| Solvent | medium | Cosolvent | medium | mixture | Temp (° C.) | Temp (g/min m²) |
| N-butylpyrrolidone | 100 | — | — | 45 | 48 | — |
| gamma-butyrolactone | 100 | — | — | 45 | 51 | 9.31 |
| Isophorone | 100 | — | — | 45 | 72 | 16.59 |
| Triacetin | 100 | — | — | 45 | 76 | 0.69 |
| Ethyl Acetoacetate | 100 | — | — | 45 | 76 | 37.76 |
| Triethylphosphate | 80 | Ethyl | 20 | 45 | 46 | — |
| | | Acetoacetate | | | | |
| Triethylphosphate | 80 | Dowanol ™ PM¹ | 20 | 45 | 58 | — |

¹Propylene glycol methyl ether commercially available from The Dow Chemical Company.

The dissolution temperature of the fluoropolymer dispersed in the organic medium may be less than 77° C., such as less than 70° C., such as less than 65° C., such as less than 60° C., such as less than 55° C., such as less than 50° C. The dissolution temperature of the fluoropolymer dispersed in the organic medium may range from 30° C. to 77° C., such as from 30° C. to 70° C., such as 30° C. to 65° C., such as 30° C. to 60° C., such as 30° C. to 55° C., such as 30° C. to 50° C. The dissolution temperature may be measured according to the method discussed above.

The organic medium may comprise, for example, butyl pyrrolidone, trialkyl phosphate, 1,2,3-triacetoxypropane, 3-methoxy-N,N-dimethylpropanamide, ethyl acetoacetate, gamma-butyrolactone, propylene glycol methyl ether, cyclohexanone, propylene carbonate, dimethyl adipate, propylene glycol methyl ether acetate, dibasic ester (DBE), dibasic ester 5 (DBE-5), 4-hydroxy-4-methyl-2-pentanone (diacetone alcohol), propylene glycol diacetate, dimethyl phthalate, methyl isoamyl ketone, ethyl propionate, 1-ethoxy-2-propanol, dipropylene glycol dimethyl ether, saturated and unsaturated linear and cyclic ketones (commercially available as a mixture thereof as Eastman™ C-11 Ketone from Eastman Chemical Company), diisobutyl ketone, acetate esters (commercially available as Exxate™ 1000 from Hallstar), tripropylene glycol methyl ether, diethylene glycol ethyl ether acetate, or combinations thereof. The trialkyl phosphate may comprise, for example, trimethylphosphate, tricthylphosphate, tripropylphosphate, tributylphosphate, or the like.

The organic medium may consist essentially of or consist of, for example, butyl pyrrolidone, trialkyl phosphate, 1,2,3-triacetoxypropane, 3-methoxy-N,N-dimethylpropanamide, ethyl acetoacetate, gamma-butyrolactone, cyclohexanone, propylene carbonate, dimethyl adipate, propylene glycol methyl ether acetate, dibasic ester (DBE), dibasic ester 5 (DBE-5), 4-hydroxy-4-methyl-2-pentanone (diacetone alcohol), propylene glycol diacetate, dimethyl phthalate, methyl isoamyl ketone, ethyl propionate, 1-ethoxy-2-propanol, saturated and unsaturated linear and cyclic ketones (commercially available as a mixture thereof as Eastman™ C-11 Ketone from Eastman Chemical Company), diisobutyl ketone, acetate esters (commercially available as Exxate™ 1000 from Hallstar), diethylene glycol ethyl ether acetate, or combinations thereof.

The organic medium may comprise a primary solvent and a co-solvent that form a homogenous continuous phase with the fluoropolymer as the dispersed phase. The primary solvent and co-solvent and relevant amounts thereof may be selected to provide a dispersion of the fluoropolymer in the organic medium at room temperature, i.e., about 23° C. Both the primary solvent and co-solvent may comprise organic solvent(s). The fluoropolymer may be soluble in the primary solvent at room temperature if used alone but use of the co-solvent with the primary solvent may allow for the fluoropolymer to be stably dispersed in the organic medium. The primary solvent may comprise, consist essentially of, or consist of, for example, butyl pyrrolidone, a trialkylphosphate, 3-methoxy-N,N-dimethylpropanamide, 1,2,3-triacetoxypropane, or combinations thereof. The co-solvent may comprise, consist essentially of, or consist of, for example, ethyl acetoacetate, gamma-butyrolactone, and/or glycol ethers such as propylene glycol methyl ether, dipropylene glycol methyl ether, propylene glycol monopropyl ether, diethylene glycol monobutyl ether, ethylene glycol monohexyl ether, and the like. The primary solvent may be present in an amount of at least 50% by weight, such as at least 65% by weight, such as at least 75 by weight, and may be present in an amount of no more than 99% by weight, such as no more than 90% by weight, such as no more than 85% by weight, based on the total weight of the organic medium. The primary solvent may be present in an amount of 50% to 99% by weight, such as 65% to 90% by weight, such as 75% to 85% by weight, based on the total weight of the organic medium. The co-solvent may be present in an amount of at least 1% by weight, such as at least 10% by weight, such as at least 15% by weight, and may be present in an amount of no more than 50% by weight, such as no more than 35% by weight, such as no more than 25% by weight. The co-solvent may be present in an amount of 1% to 50% by weight, such as 10% to 35% by weight, such as 15% to 25% by weight, based on the total weight of the organic medium.

The organic medium may also have an evaporation rate greater than 80 g/min m², at 180° C., such as greater than 90 g/min m², at 180° C., such as greater than 100 g/min m², at 180° C.

The liquid medium may comprise an aqueous medium. As used herein, the term “aqueous medium” refers to a liquid medium comprising at least 50% by weight water, based on the total weight of the organic medium. Such aqueous mediums may comprise less than 40% by weight organic solvent, or less than 30% by weight organic solvent, or less than 20% by weight organic solvent, or less than 10% by weight organic solvent, or less than 5% by weight organic solvent, or less than 1% by weight organic solvent, or less than 0.1% by weight organic solvent, based on the total weight of the aqueous medium. Water may comprise more than 50% by weight of the aqueous medium, such as at least 60% by weight, such as at least 70% by weight, such as at least 80% by weight, such as at least 90% by weight, such as at least 95% by weight, such as at least 99% by weight, such as at least 99.9% by weight, such as 100% by weight, based on the total weight of the aqueous medium. Water may comprise 50.1% to 100% by weight, such as 70% to 100% by weight, such as 80% to 100% by weight, such as 90% to 100% by weight, such as 95% to 100% by weight, such as 99% to 100% by weight, such as 99.9% to 100% by weight, based on the total weight of the aqueous medium.

The liquid medium may be present in an amount of at least 10% by weight, such as at least 15% by weight, such as at least 20% by weight, such as at least 30% by weight, such as at least 35% by weight, based on the total weight of the slurry composition. The liquid medium may be present in an amount of no more than 80% by weight, such as no more than 60% by weight, such as no more than 50% by weight, such as no more than 40% by weight, such as no more than 35% by weight, such as no more than 30% by weight, such as no more than 25% by weight, based on the total weight of the slurry composition. The liquid medium may be present in an amount of such as 10% to 80% by weight, such as 10% to 60% by weight, such as 10% to 50% by weight, such as 10% to 40% by weight, such as 10% to 35% by weight, such as 10% to 30% by weight, such as 10% to 25% by weight, such as 15% to 80% by weight, such as 15% to 60% by weight, such as 15% to 50% by weight, such as 15% to 40% by weight, such as 15% to 35% by weight, such as 15% to 30% by weight, such as 15% to 25% by weight, such as 20% to 80% by weight, such as 20% to 60% by weight, such as 20% to 50% by weight, such as 20% to 40% by weight, such as 20% to 35% by weight, such as 20% to 30% by weight, such as 20% to 25% by weight, such as 30% to 80% by weight, such as 30% to 60% by weight, such as 30% to 50% by weight, such as 30% to 40% by weight, such as 30% to 35% by weight, such as 35% to 80% by weight, such as 35% to 60% by weight, such as 35% to 50% by weight, such as 35% to 40% by weight, based on the total weight of the slurry composition.

The binder composition and/or slurry composition may be substantially free, essentially free, or completely free of N-Methyl-2-pyrrolidone (NMP). As used herein, the binder composition and/or slurry composition is “substantially free” of NMP if NMP is present, if at all, in an amount of less than 5% by weight, based on the total weight of the binder composition and/or slurry composition. As used herein, the binder composition and/or slurry composition is “essentially free” of NMP if NMP is present, if at all, in an amount of less than 0.3% by weight, based on the total weight of the binder composition and/or slurry composition. As used herein, the binder composition and/or slurry composition is “completely free” of NMP if NMP is not present in the binder composition and/or slurry composition, i.e., 0.000% by weight, based on the total weight of the binder composition and/or slurry composition.

The binder composition and/or slurry composition may be substantially free, essentially free, or completely free of ketones such as methyl ethyl ketone, cyclohexanone, isophorone, acetophenone.

The binder composition and/or slurry composition may be substantially free, essentially free, or completely free of ethers such as the C₁ to C₄ alkyl ethers of ethylene or propylene glycol.

The fluoropolymer and/or slurry composition may be substantially free, essentially free, or completely free of fluoroethylene, such as tetrafluoroethylene.

The fluoropolymer and/or slurry composition may be substantially free, essentially free, or completely free of fluorosurfactant.

The binder composition and/or slurry composition may be substantially free, essentially free, or completely free of siloxane.

As noted above, the binder composition and/or slurry composition may optionally further comprise a separately added crosslinking agent for reaction with the addition polymer and/or (meth)acrylic polymer. The crosslinking agent should be soluble or dispersible in the organic medium and be reactive with active hydrogen groups of the addition polymer and/or (meth)acrylic polymer, such as the carboxylic acid groups and the hydroxyl groups, if present. Non-limiting examples of suitable crosslinking agents include aminoplast resins and polyepoxides.

Examples of aminoplast resins for use as a crosslinking agent are those which are formed by reacting a triazine such as melamine or benzoguanamine with formaldehyde. These reaction products contain reactive N-methylol groups. Usually, these reactive groups are etherified with methanol, ethanol, butanol including mixtures thereof to moderate their reactivity. For the chemistry preparation and use of aminoplast resins, see “The Chemistry and Applications of Amino Crosslinking Agents or Aminoplast”, Vol. V, Part II, page 21 ff., edited by Dr. Oldring; John Wiley & Sons/Cita Technology Limited, London, 1998. These resins are commercially available under the trademark MAPRENAL® such as MAPRENAL MF980 and under the trademark CYMEL® such as CYMEL 303 and CYMEL 1128, available from Cytec Industries.

Examples of polyepoxide crosslinking agents are epoxy-containing addition polymers such as those prepared from glycidyl methacrylate copolymerized with other vinyl monomers, polyglycidyl ethers of polyhydric phenols such as the diglycidyl ether of bisphenol A; and cycloaliphatic polyepoxides such as 3,4-epoxycyclohexylmethyl-3,4-epoxycyclohexane carboxylate and bis(3,4-epoxy-6-methylcyclohexyl-methyl) adipate.

In addition to promoting the cross-linking of the addition polymer and/or (meth)acrylic polymer, the crosslinking agents, including those associated with crosslinking monomers and separately added crosslinking agents, react with the hydrophilic groups, such as active hydrogen functional groups of the addition polymer and/or (meth)acrylic polymer preventing these groups from absorbing moisture that could be problematic in a lithium ion battery.

The separately added crosslinker may be present in the binder in amounts of up to 25% by weight, such as 0.1% to 25% by weight, such as 0.1% to 15% by weight, such as 1% to 25% by weight, such as 1% to 15% by weight, the % by weight being based on the total weight of the binder solids.

The binder solids may be present in the slurry composition in amounts of at least 0.1% by weight, such as at least 0.5% by weight, such as at least 1% by weight, such as at least 1.5% by weight, such as at least 2% by weight, based on the total solids weight of the slurry. The binder solids may be present in the slurry composition in amounts of no more than 20% by weight, such as no more than 15% by weight, such as no more than 10% by weight, such as no more than 7.5% by weight, such as no more than 5% by weight, such as no more than 4% by weight, such as no more than 3% by weight, based on the total solids weight of the slurry. The binder solids may be present in the slurry composition in amounts of 0.1% to 20% by weight, such as 0.1% to 15% by weight, such as 0.1% to 10% by weight, such as 0.1% to 7.5% by weight, such as 0.1% to 5% by weight, such as 0.1% to 4% by weight, such as 0.1% to 3% by weight, such as 0.5% to 20% by weight, such as 0.5% to 15% by weight, such as 0.5% to 10% by weight, such as 0.5% to 7.5% by weight, such as 0.5% to 5% by weight, such as 0.5% to 4% by weight, such as 0.5% to 3% by weight, such as 1% to 20% by weight, such as 1% to 15% by weight, such as 1% to 10% by weight, such as 1% to 7.5% by weight, such as 1% to 5% by weight, such as 1% to 4% by weight, such as 1% to 3% by weight, such as 1.5% to 20% by weight, such as 1.5% to 15% by weight, such as 1.5% to 10% by weight, such as 1.5% to 7.5% by weight, such as 1.5% to 5% by weight, such as 1.5% to 4% by weight, such as 1.5% to 3% by weight, such as 2% to 20% by weight, such as 2% to 15% by weight, such as 2% to 10% by weight, such as 2% to 7.5% by weight, such as 2% to 5% by weight, such as 2% to 4% by weight, such as 2% to 3% by weight, based on the total solids weight of the slurry.

The separately added crosslinking agent may be present in the slurry composition in an amount of 0.0001% to 5% by weight, such as 0.0002% to 2% by weight, such as 0.0002 to 1% by weight, such as 0.0005 to 0.5% by weight, such as 0.0005 to 0.3% by weight, such as 0.1% to 5% by weight, based on the total solids weight of the slurry composition.

The slurry composition may optionally further comprise an electrochemically active material. The material constituting the electrochemically active material contained in the slurry is not particularly limited and a suitable material can be selected according to the type of an electrical storage device of interest.

The electrochemically active material may comprise a material for use as an active material for a positive electrode. The electrochemically active material may comprise a material capable of incorporating lithium (including incorporation through lithium intercalation/deintercalation), a material capable of lithium conversion, or combinations thereof. Non-limiting examples of electrochemically active materials capable of incorporating lithium include LiCoO₂, LiNiO₂, LiFePO₄, LiCoPO₄, LiMnO₂, LiMn₂O₄, Li(NiMnCo)O₂. Li(NiCoAl)O₂, carbon-coated LiFePO₄, and combinations thereof. Non-limiting examples of materials capable of lithium conversion include sulfur, LiO₂, FeF₂ and FeF₃, Si, aluminum, tin, SnCo, Fe₃O₄, and combinations thereof.

The electrochemically active material may comprise a material for use as an active material for a negative electrode. The electrochemically active material may comprise graphite, lithium titanate, silicon compounds, tin, tin compounds, sulfur, sulfur compounds, or a combination thereof.

The electrochemically active material may be present in the slurry in amounts of 45% to 99% by weight, such as 50% to 99% by weight, such as 55% to 99% by weight, such as 60% to 99% by weight, such as 65% to 99% by weight, such as 70% to 99% by weight, such as 75% to 99% by weight, such as 80% to 99% by weight, such as 85% to 99% by weight, such as 90% to 99% by weight, such as 91% to 99% by weight, such as 94% to 99% by weight, such as 95% to 99% by weight, such as 96% to 99% by weight, such as 97% to 99% by weight, such as 98% to 99% by weight, such as 45% to 98% by weight, such as 50% to 98% by weight, such as 55% to 98% by weight, such as 60% to 98% by weight, such as 65% to 98% by weight, such as 70% to 98% by weight, such as 75% to 98% by weight, such as 80% to 98% by weight, such as 85% to 98% by weight, such as 90% to 98% by weight, such as 91% to 98% by weight, such as 94% to 98% by weight, such as 95% to 98% by weight, such as 96% to 98% by weight, such as 97% to 98% by weight, such as 45% to 96% by weight, such as 50% to 96% by weight, such as 55% to 96% by weight, such as 60% to 96% by weight, such as 65% to 96% by weight, such as 70% to 96% by weight, such as 75% to 96% by weight, such as 80% to 96% by weight, such as 85% to 96% by weight, such as 90% to 96% by weight, such as 91% to 96% by weight, such as 94% to 96% by weight, such as 95% to 96% by weight, based on the total solids weight of the slurry.

The slurry composition of the present disclosure may optionally further comprise an electrically conductive agent. Non-limiting examples of electrically conductive agents include carbonaceous materials such as, activated carbon, carbon black such as acetylene black and furnace black, graphite, graphene, carbon nanotubes, carbon fibers, fullerene, and combinations thereof.

The electrically conductive agent may be present in the slurry in amounts of at least 0.1% by weight, such as at least 0.5% by weight, such as at least 1% by weight, such as at least 1.5% by weight, such as at least 2% by weight, based on the total solids weight of the slurry. The electrically conductive agent may be present in the slurry in amounts of no more than 20% by weight, such as no more than 15% by weight, such as no more than 10% by weight, such as no more than 7.5% by weight, such as no more than 5% by weight, such as no more than 4% by weight, such as no more than 3% by weight, such as no more than 2.5% by weight, based on the total solids weight of the slurry. The electrically conductive agent may be present in the slurry in amounts of 0.1% to 20% by weight, such as 0.1% to 15% by weight, such as 0.1% to 10% by weight, such as 0.1% to 7.5% by weight, such as 0.1% to 5% by weight, such as 0.1% to 4% by weight, such as 0.1% to 3% by weight, such as 0.1% to 2.5% by weight, such as 0.5% to 20% by weight, such as 0.5% to 15% by weight, such as 0.5% to 10% by weight, such as 0.5% to 7.5% by weight, such as 0.5% to 5% by weight, such as 0.5% to 4% by weight, such as 0.5% to 3% by weight, such as 0.5% to 2.5% by weight, such as 1% to 20% by weight, such as 1% to 15% by weight, such as 1% to 10% by weight, such as 1% to 7.5% by weight, such as 1% to 5% by weight, such as 1% to 4% by weight, such as 1% to 3% by weight, such as 1% to 2.5% by weight, such as 1.5% to 20% by weight, such as 1.5% to 15% by weight, such as 1.5% to 10% by weight, such as 1.5% to 7.5% by weight, such as 1.5% to 5% by weight, such as 1.5% to 4% by weight, such as 1.5% to 3% by weight, such as 1.5% to 2.5% by weight, such as 2% to 20% by weight, such as 2% to 15% by weight, such as 2% to 10% by weight, such as 2% to 7.5% by weight, such as 2% to 5% by weight, such as 2% to 4% by weight, such as 2% to 3% by weight, such as 2% to 2.5% by weight, based on the total solids weight of the slurry.

The slurry composition may be in the form of an electrode slurry composition comprising the binder, electrochemically active material and electrically conductive material, each as described above. The electrode slurry may comprise such materials present in the slurry composition in the amounts described above. For example, the electrode slurry composition may comprise the electrochemically active material present in amounts of 45% to 95% by weight, such as 70% to 98% by weight; the binder solids present in amounts of 1% to 20% by weight, such as 1% to 10% by weight, such as 5% to 10% percent by weight; and the electrically conductive agent present in amounts of 1% to 20% by weight, such as 5% to 10% by weight, the percentages by weight based on the total solids weight of the electrode slurry composition.

The present disclosure is also directed to a slurry composition comprising a fluoropolymer; a non-polymeric alkoxysilane compound; an electrochemically active material and/or an electrically conductive agent; and a liquid medium. The fluoropolymer, electrochemically active material and/or an electrically conductive agent, and liquid medium may be any of those described above in the amounts described above. The non-polymeric alkoxysilane compound may be any of those described above. The non-polymeric alkoxysilane compound may be present in an amount of at least 0.1% by weight, such as at least 0.25% by weight, such as at least 0.5% by weight, such as at least 1% by weight, based on the total weight of the binder solids. The non-polymeric alkoxysilane compound may be present in an amount of no more than 10% by weight, such as no more than 5% by weight, such as no more than 3% by weight, based on the total weight of the binder solids. The non-polymeric alkoxysilane compound may be present in an amount of 0.1% to 10% by weight, such as 0.1% to 5% by weight, such as 0.1% to 3% by weight, such as 0.25% to 10% by weight, such as 0.25% to 5% by weight, such as 0.25% to 3% by weight, such as 0.5% to 10% by weight, such as 0.5% to 5% by weight, such as 0.5% to 3% by weight, such as 1% to 10% by weight, such as 1% to 5% by weight, such as 1% to 3% by weight, based on the total weight of the binder solids.

The electrode slurry composition comprising the organic medium, electrochemically active material, electrically conductive material, binder dispersion (which may include a separately added crosslinking agent), additional organic medium, if needed, and optional ingredients, may be prepared by combining the ingredients to form the slurry. These substances can be mixed together by agitation with a known means such as a stirrer, bead mill or high-pressure homogenizer.

As for mixing and agitation for the manufacture of the electrode slurry composition, a mixer capable of stirring these components to such an extent that satisfactory dispersion conditions are met should be selected. The degree of dispersion can be measured with a particle gauge and mixing and dispersion may be carried out to ensure that agglomerates of 100 microns or more are not present. Examples of the mixers which meets this condition include ball mill, sand mill, pigment disperser, grinding machine, extruder, rotor stator, pug mill, ultrasonic disperser, homogenizer, planetary mixer, Hobart mixer, and combinations thereof.

The slurry composition may have a solids content of at least 30% by weight, such as at least 40% by weight, such as at least 50% by weight, such as at least 55%, such as at least 60%, such as at least 65%, such as at least 71%, such as at least 75%, and may be no more than 90% by weight, such as no more than 85% by weight, such as no more than 75% by weight, the % by weight based on the total weight of the slurry composition. The slurry composition may have a solids content of 30% to 90% by weight, such as 40% to 85% by weight, such as 50% to 85% by weight, such as 55% to 85% by weight, such as 60% to 85% by weight, such as 65% to 85% by weight, such as 71% to 85% by weight, such as 75% to 85% by weight, based on the total weight of the slurry composition.

The present disclosure is also directed to an electrode comprising an electrical current collector and a film on the electrical current collector, wherein the film comprises an electrochemically active material, a fluoropolymer, and an addition polymer comprising a silicon-containing functional group comprising at least one alkoxy substituent. The film may optionally further comprise a separately added crosslinking agent and/or a (meth)acrylic polymer. The film may be deposited from the electrode slurry composition described above. The electrode may be a positive electrode or a negative electrode and may be manufactured by applying the above-described slurry composition to the surface of the current collector to form a coating film, and subsequently drying and/or curing the coating film. The coating film may have a thickness of at least 1 micron, such as 1 to 500 microns (μm), such as 1 to 150 μm, such as 25 to 150 μm, such as 30 to 125 μm. The coating film may comprise a cross-linked coating, and the film may further comprise the residue of a crosslinking agent. The current collector may comprise a conductive material, and the conductive material may comprise a metal such as iron, copper, aluminum, nickel, and alloys thereof, as well as stainless steel. For example, the current collector may comprise aluminum or copper in the form of a mesh, sheet or foil. Although the shape and thickness of the current collector are not particularly limited, the current collector may have a thickness of about 0.001 to 0.5 mm, such as a mesh, sheet or foil having a thickness of about 0.001 to 0.5 mm.

The film comprising the electrochemically active material; the fluoropolymer; and the addition polymer comprising a silicon-containing functional group comprising at least one alkoxy substituent, and optionally the (meth)acrylic polymer and/or separately added crosslinking agent, may have an adhesion to the current collector at least 10% higher than a comparative film that does not include the addition polymer comprising a silicon-containing functional group comprising at least one alkoxy substituent, such as at least 15% higher, such as at least 20% higher, such as at least 30% higher, such as at least 40% higher, as measured by the PEEL STRENGTH TEST described in the examples below. As used herein, a comparative film means a film applied from a slurry composition having the same fluoropolymer, liquid medium, and electrochemically active material and/or conductive material but lacks the addition polymer comprising a silicon-containing functional group comprising at least one alkoxy substituent.

In addition, the current collector may be pretreated with a pretreatment composition prior to depositing the slurry composition. As used herein, the term “pretreatment composition” refers to a composition that upon contact with the current collector, reacts with and chemically alters the current collector surface and binds to it to form a protective layer. The pretreatment composition may be a pretreatment composition comprising a group IIIB and/or IVB metal. As used herein, the term “group IIIB and/or IVB metal” refers to an element that is in group IIIB or group IVB of the CAS Periodic Table of the Elements as is shown, for example, in the Handbook of Chemistry and Physics, 63^{rd} edition (1983). Where applicable, the metal themselves may be used, however, a group IIIB and/or IVB metal compound may also be used. As used herein, the term “group IIIB and/or IVB metal compound” refers to compounds that include at least one element that is in group IIIB or group IVB of the CAS Periodic Table of the Elements. Suitable pretreatment compositions and methods for pretreating the current collector are described in U.S. Pat. No. 9,273,399 at col. 4, line 60 to col. 10, line 26, the cited portion of which is incorporated herein by reference. The pretreatment composition may be used to treat current collectors used to produce positive electrodes or negative electrodes.

The method of applying the slurry composition to the current collector is not particularly limited. The slurry composition may be applied by doctor blade coating, dip coating, reverse roll coating, direct roll coating, gravure coating, extrusion coating, immersion or brushing. Although the application quantity of the slurry composition is not particularly limited, the thickness of the coating formed after the organic medium is removed may be 25 to 150 microns (μm), such as 30 to 125 μm.

Drying and/or crosslinking the coating film after application, if applicable, can be done, for example, by heating at elevated temperature, such as at least 50° C., such as at least 60° C., such as 50-145° C., such as 60-120° C., such as 65-110° C. The time of heating will depend somewhat on the temperature. Generally, higher temperatures require less time for curing. Typically, curing times are for at least 5 minutes, such as 5 to 60 minutes. The temperature and time should be sufficient such that the addition polymer and/or the (meth)acrylic polymer in the cured film is crosslinked (if applicable), that is, covalent bonds are formed between co-reactive groups on the addition polymer and/or the (meth)acrylic polymer chain(s), such as carboxylic acid groups and hydroxyl groups and the N-methylol and/or the N-methylol ether groups of an aminoplast, or in the case of a self-curing addition polymer, the N-alkoxymethyl amide groups. The extent of cure or crosslinking may be measured as resistance to solvents such as methyl ethyl ketone (MEK). The test is performed as described in ASTM D-540293. The number of double rubs, one back and forth motion, is reported. This test is often referred to as “MEK Resistance”. Accordingly, the addition polymer and/or the (meth)acrylic polymer and crosslinking agent (inclusive of self-curing polymers and polymers with separately added crosslinking agents) is isolated from the binder composition, deposited as a film, and heated for the temperature and time that the binder film is heated. The film is then measured for MEK Resistance with the number of double rubs reported. Accordingly, a crosslinked addition polymer and/or the (meth)acrylic polymer will have an MEK Resistance of at least 50 double rubs, such as at least 75 double rubs. Also, the crosslinked addition polymer and/or the (meth)acrylic polymer may be substantially solvent resistant to the solvents of the electrolyte mentioned below. Other methods of drying the coating film include ambient temperature drying, microwave drying and infrared drying, and other methods of curing the coating film include e-beam curing and UV curing.

During discharge of a lithium ion electrical storage device, lithium ions may be released from the negative electrode and carry the current to the positive electrode. This process may include the process known as deintercalation. During charging, the lithium ions migrate from the electrochemically active material in the positive electrode to the negative electrode where they become embedded in the electrochemically active material present in the negative electrode. This process may include the process known as intercalation.

The present disclosure is also directed to an electrical storage device. An electrical storage device according to the present disclosure can be manufactured by using the above electrodes prepared from the electrode slurry composition of the present disclosure. The electrical storage device comprises an electrode, a counter electrode, and an electrolyte. The electrode, counter-electrode or both may comprise the electrode of the present disclosure, as long as one electrode is a positive electrode, and one electrode is a negative electrode. Electrical storage devices according to the present disclosure include a cell, a battery, a battery pack, a secondary battery, a capacitor, and a supercapacitor.

The electrical storage device includes an electrolytic solution and can be manufactured by using parts such as a separator in accordance with a commonly used method. As a more specific manufacturing method, a negative electrode and a positive electrode are assembled together with a separator there between, the resulting assembly is rolled or bent in accordance with the shape of a battery and put into a battery container, an electrolytic solution is injected into the battery container, and the battery container is sealed up. The shape of the battery may be like a coin, button, or sheet, cylindrical, square or flat.

The electrolytic solution may be liquid or gel, and an electrolytic solution which can serve effectively as a battery may be selected from among known electrolytic solutions which are used in electrical storage devices in accordance with the types of a negative electrode active material and a positive electrode active material. The electrolytic solution may be a solution containing an electrolyte dissolved in a suitable solvent. The electrolyte may be conventionally known lithium salt for lithium ion secondary batteries. Examples of the lithium salt include LiClO₄, LiBF₄, LiPF₆, LiCF₃CO₂, LiAsF₆, LiSbF₆, LiB₁₀Cl₁₀, LiAlCl₄, LiCl, LiBr, LiB(C₂H₅)₄, LiB(C₆H₅)₄, LiCF₃SO₃, LiCH₃SO₃, LiC₄F₉SO₃, Li(CF₃SO₂)₂N, LiB₄CH₃SO₃Li and CF₃SO₃Li. The solvent for dissolving the above electrolyte is not particularly limited and examples thereof include carbonate compounds such as propylene carbonate, ethylene carbonate, butylene carbonate, dimethyl carbonate, methyl ethyl carbonate and diethyl carbonate; lactone compounds such as γ-butyl lactone; ether compounds such as trimethoxymethane, 1,2-dimethoxyethane, diethyl ether, 2-ethoxyethane, tetrahydrofuran and 2-methyltetrahydrofuran; and sulfoxide compounds such as dimethyl sulfoxide. The concentration of the electrolyte in the electrolytic solution may be 0.5 to 3.0 mole/L, such as 0.7 to 2.0 mole/L.

As used herein, the term “polymer” refers broadly to oligomers and both homopolymers and copolymers. The term “resin” is used interchangeably with “polymer”.

The terms “acrylic” and “acrylate” are used interchangeably (unless to do so would alter the intended meaning) and include acrylic acids, anhydrides, and derivatives thereof, such as their C₁-C₅ alkyl esters, lower alkyl-substituted acrylic acids, e.g., C₁-C₂ substituted acrylic acids, such as methacrylic acid, 2-ethylacrylic acid, etc., and their C₁-C₄ alkyl esters, unless clearly indicated otherwise. The terms “(meth)acrylic” or “(meth)acrylate” are intended to cover both the acrylic/acrylate and methacrylic/methacrylate forms of the indicated material, e.g., a (meth)acrylate monomer.

As used herein molecular weights are determined by gel permeation chromatography using a polystyrene standard. Unless otherwise indicated molecular weights are on a weight average basis. As used herein, the term “weight average molecular weight” or “(M_{w})” means the weight average molecular weight (M_{w}) as determined by gel permeation chromatography using a polystyrene standard according to ASTM D6579-11 (“Standard Practice for Molecular Weight Averages and Molecular Weight Distribution of Hydrocarbon, Rosin and Terpene Resins by Size Exclusion Chromatography”. UV detector; 254 nm, solvent: unstabilised THF, retention time marker: toluene, sample concentration: 2 mg/ml). As used herein, the term “number average molecular weight” or “(Mₙ)” means the number average molecular weight (Mₙ) as determined by gel permeation chromatography using a polystyrene standard according to ASTM D6579-11 (“Standard Practice for Molecular Weight Averages and Molecular Weight Distribution of Hydrocarbon, Rosin and Terpene Resins by Size Exclusion Chromatography”. UV detector; 254 nm, solvent: unstabilised THF, retention time marker: toluene, sample concentration: 2 mg/ml).

The term “glass transition temperature” as used herein is a theoretical value, being the glass transition temperature as calculated by the method of Fox on the basis of monomer composition of the monomer charge according to T. G. Fox, Bull. Am. Phys. Soc. (Ser. II) 1, 123 (1956) and J. Brandrup, E. H. Immergut, Polymer Handbook 3rd edition, John Wiley, New York, 1989.

As used herein, unless otherwise defined, the term substantially free means that the component is present, if at all, in an amount of less than 5% by weight, based on the total weight of the slurry composition.

As used herein, unless otherwise defined, the term essentially free means that the component is present, if at all, in an amount of less than 1% by weight, based on the total weight of the slurry composition.

As used herein, unless otherwise defined, the term completely free means that the component is not present in the slurry composition, i.e., 0.00% by weight, based on the total weight of the slurry composition.

As used herein, the term “total solids” refers to the non-volatile components of the slurry composition of the present disclosure and specifically excludes the organic medium.

As used herein, the term “binder solids” refers to the film-forming components that form the binder of the slurry composition and/or bind the components together in the electrode film. The binder solids include the fluoropolymer, the addition polymer, and, if present, the (meth)acrylic polymer, and/or the separately added crosslinking agent.

As used herein, the term “residue of” when referring to the composition of a polymer refers to a singular molecular unit within the polymer that results from incorporation (i.e., reaction) of a monomer during polymerization.

As used herein, the term “consists essentially of” includes the recited material or steps and those that do not materially affect the basic and novel characteristics of the claimed disclosure.

As used herein, the term “consists of” excludes any element, step or ingredient not recited.

For purposes of the detailed description, it is to be understood that the disclosure may assume various alternative variations and step sequences, except where expressly specified to the contrary. Moreover, other than in any operating examples, or where otherwise indicated, all numbers such as those expressing values, amounts, percentages, ranges, subranges and fractions may be read as if prefaced by the word “about,” even if the term does not expressly appear. Accordingly, unless indicated to the contrary, the numerical parameters set forth in the following specification and attached claims are approximations that may vary depending upon the desired properties to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. Where a closed or open-ended numerical range is described herein, all numbers, values, amounts, percentages, subranges and fractions within or encompassed by the numerical range are to be considered as being specifically included in and belonging to the original disclosure of this application as if these numbers, values, amounts, percentages, subranges and fractions had been explicitly written out in their entirety.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard variation found in their respective testing measurements.

As used herein, unless indicated otherwise, a plural term can encompass its singular counterpart and vice versa, unless indicated otherwise. For example, although reference is made herein to “an” electrochemically active material, “a” fluoropolymer, “an” addition polymer, “a” (meth)acrylic polymer, and “an” electrically conductive agent, a combination (i.e., a plurality) of these components can be used. In addition, in this application, the use of “or” means “and/or” unless specifically stated otherwise, even though “and/or” may be explicitly used in certain instances.

As used herein, “including.” “containing” and like terms are understood in the context of this application to be synonymous with “comprising” and are therefore open-ended and do not exclude the presence of additional undescribed or unrecited elements, materials, ingredients, or method steps. As used herein, “consisting of” is understood in the context of this application to exclude the presence of any unspecified element, ingredient, or method step. As used herein, “consisting essentially of” is understood in the context of this application to include the specified elements, materials, ingredients, or method steps “and those that do not materially affect the basic and novel characteristic(s)” of what is being described. Although various embodiments of the disclosure have been described in terms of “comprising”, embodiments consisting essentially of or consisting of are also within the scope of the present disclosure.

As used herein, the terms “on,” “onto.” “applied on,” “applied onto,” “formed on.” “deposited on,” “deposited onto,” mean formed, overlaid, deposited, or provided on but not necessarily in contact with the surface. For example, a composition “deposited onto” a substrate does not preclude the presence of one or more other intervening coating layers of the same or different composition located between the electrodepositable coating composition and the substrate.

Whereas specific embodiments of the disclosure have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosure which is to be given the full breadth of the claims appended and any and all equivalents thereof. Each of the characteristics and examples described herein, and combinations thereof, may be said to be encompassed by the present disclosure.

Illustrating the disclosure are the following examples, which, however, are not to be considered as limiting the disclosure to their details. Unless otherwise indicated, all parts and percentages in the following examples, as well as throughout the specification, are by weight.

### EXAMPLES

### Preparation of Silane-Functional Addition Polymers by Continuous Stirred-Tank Reactor (CSTR)

A 300 mL electrically heated continuous stirred-tank reactor with an internal cooling coil was filled with 2-butoxyethanol and the temperature was adjusted to the set temperature as indicated in Table 1 below. The first reactor charge from Table 1 below was fed to the reactor from a feed tank at 60 mL/minute, resulting in a residence time of five minutes. The reactor was kept volumetrically full at a pressure of 400-600 psi. The temperature was held constant at the set temperature. The reactor output was drained to a waste vessel for the first fifteen minutes and was then diverted to a 4000 mL continuous stirred tank reactor fitted with a pressure relief valve set to vent at 35 psi. At this point the second reactor charge was fed to the second reactor at a rate that matched the initiator level. The contents of the second reactor were maintained at a set temperature from Table 1. When 2100 mL of product had been added to the second reactor, the outlet valve was opened and the resin was fed to a collection vessel at a rate that maintained a constant fill level, resulting in a 35-minute residence time. The collected resin was further dissolved in triethyl phosphate (TEP) to match the targeted solids from Table 1 for polymer F—H.

TABLE 1

| | | Polymer: | | | | | | | |
|---|---|---|---|---|---|---|---|---|---|
| | | A | B | C | D | E | F | G | H |
| First reactor | Butyl acrylate | 1375 | 1375 | 1375 | 1375 | 1375 | — | — | — |
| charge | Styrene | 500 | 400 | 300 | 225 | 125 | 240 | 240 | 240 |
| (grams) | 2-Ethylhexyl | 375 | 350 | 325 | 275 | 250 | 960 | 1080 | 1200 |
| | acrylate | | | | | | | | |
| | Methyl | — | — | — | — | — | 720 | 720 | 720 |
| | methacrylate | | | | | | | | |
| | A-174¹ | 250 | 375 | 500 | 625 | 750 | 480 | 360 | 240 |
| | Butyl Cellosolve | — | — | — | — | — | 12 | 12 | 12 |
| | Dowanol PM² | 50 | 50 | 50 | 50 | 50 | — | — | — |
| | di-t-amyl peroxide | 50 | 50 | 50 | 50 | 50 | 48 | 48 | 48 |
| Second | di-t-amyl peroxide | 25 | 25 | 25 | 25 | 25 | 21 | 21 | 21 |
| reactor charge | | | | | | | | | |
| (grams) | | | | | | | | | |
| Monomer | Butyl acrylate | 55 | 55 | 55 | 55 | 55 | — | — | — |
| composition | Styrene | 20 | 16 | 12 | 9 | 5 | 10 | 10 | 10 |
| (weight %) | 2-Ethylhexyl | 15 | 14 | 13 | 11 | 10 | 40 | 45 | 50 |
| | acrylate | | | | | | | | |
| | Methyl | — | — | — | — | — | 30 | 30 | 30 |
| | methacrylate | | | | | | | | |
| | A-174¹ | 10 | 15 | 20 | 25 | 30 | 20 | 15 | 10 |
| Reactor | First reactor | 210 | 210 | 210 | 210 | 210 | 210 | 210 | 210 |
| temperature | Second reactor | 170 | 170 | 170 | 170 | 170 | 170 | 170 | 170 |
| (° C.) | | | | | | | | | |
| Initiator level | First reactor | 2 | 2 | 2 | 2 | 2 | 2 | 2 | 2 |
| (% by weight | Second reactor | 1 | 1 | 1 | 1 | 1 | 1 | 1 | 1 |
| on monomers) | | | | | | | | | |
| | Solids % | 100 | 100 | 100 | 100 | 100 | 80 | 80 | 80 |

¹A-174 is short of Silquest A-174 silane (gamma-methacryloxypropyltrimethoxysilane) provide by Momentive.
²Dipropylene glycol methyl ether solvent available from Dow Chemical Company (Midland, MI).

The properties of the Polymers A-H are summarized in Table 2. The total free monomer was determined using gas chromatography. Mn and Mw were determined as previously described. Tg was calculated as a theoretical value using the Fox Equation. Polydispersity index (PDI) was calculated by dividing Mw by Mn.

TABLE 2

| | Polymer: | | | | | | | |
|---|---|---|---|---|---|---|---|---|
| | A | B | C | D | E | F | G | H |
| Total free monomer | 0.90 | 0.55 | 0.81 | 0.76 | 0.86 | 1.34 | 1.41 | 1.11 |
| (weight %) | | | | | | | | |
| Mw | 7326 | 7457 | 6999 | 6619 | 6189 | 6424 | 6349 | 4738 |
| Mn | 2760 | 2627 | 2541 | 2463 | 2371 | 2064 | 2068 | 1839 |
| PDI | 2.7 | 2.8 | 2.8 | 2.7 | 2.6 | 3.1 | 3.1 | 2.6 |
| Calculated Tg (° C.) | −25 | −25 | −25 | −25 | −25 | 14 | 9 | 4 |

### Preparation of Silane-Functional Addition Polymers by Batch Process

Preparation of Silane-functional Acrylic Polymer “I”: Using the ingredients in Table 3 below, Charge #1 was added to a 2-liter, 4 necked flask equipped with a motor driven stainless stir blade, water-cooled condenser and a heating mantle with a thermometer connected through a temperature feedback control device. The contents of the flask were heated to 120° C. under nitrogen blanket. Charge #2 was added into the flask through an addition funnel over 240 minutes. 5 minutes after the addition of Charge #2 started, Charge #3 was added into the flask through a separate addition funnel over 180 minutes. After the additions were complete, the two addition funnels were rinsed with Charges #4 and #5, respectively, and the reaction was held at 120° C. for 60 minutes. The mixture was then cooled down to below 90° C. and poured out into a collection container.

TABLE 3

| | Ingredients | Parts by Weight |
|---|---|---|
| Charge #1 | Ethyl Acetoacetate | 324.3 |
| Charge #2 | Ethyl Acetoacetate | 138.9 |
| | Trigonox 131 | 10.3 |
| Charge #3 | Butyl Acrylate | 327.6 |
| | Ethyl Methacrylate | 100.82 |
| | A-174 | 75.62 |
| Charge #4 | Ethyl Acetoacetate | 12.4 |
| Charge #5 | Ethyl Acetoacetate | 12.4 |

Preparation of Silane-functional Acrylic Polymer “J”: Using the ingredients in Table 4 below, Charge #1 was added to a 2-liter, 4 necked flask equipped with a motor driven stainless stir blade, water-cooled condenser and a heating mantle with a thermometer connected through a temperature feedback control device. The contents of the flask were heated to 120° C. under nitrogen blanket. Charge #2 was added into the flask through an addition funnel over 240 minutes. Five minutes after the addition of charge #2 started, charge #3 was added into the flask through a separate addition funnel over 180 minutes. After the additions were complete, the two addition funnels were rinsed with Charge #4 and #5, respectively, and the reaction was held at 120° C. for 60 minutes. The mixture was then cooled down to below 90° C. and poured out into a collection container.

TABLE 4

| | Ingredients | Parts by Weight |
|---|---|---|
| Charge #1 | Ethyl Acetoacetate | 324.3 |
| Charge #2 | Ethyl Acetoacetate | 138.9 |
| | Trigonox 131 | 10.3 |
| Charge #3 | Butyl Acrylate | 277.2 |
| | Styrene | 80.64 |
| | 2-Ethylhexyl acrylate | 70.56 |
| | A-174 | 75.62 |
| Charge #4 | Ethyl Acetoacetate | 12.4 |
| Charge #5 | Ethyl Acetoacetate | 12.4 |

Preparation of Silane-functional Acrylic Polymer “K”: Using the ingredients in Table 5 below, Charge #1 was added to a 2-liter, 4 necked flask equipped with a motor driven stainless stir blade, water-cooled condenser and a heating mantle with a thermometer connected through a temperature feedback control device. The contents of the flask were heated to 120° C. under nitrogen blanket. Charge #2 was added into the flask through an addition funnel over 240 minutes. Five minutes after the addition of charge #2 started, charge #3 was added into the flask through a separate addition funnel over 180 minutes. After the additions were complete, the two addition funnels were rinsed with Charge #4 and #5, respectively, and the reaction was held at 120° C. for 60 minutes. The mixture was then cooled down to below 90° C. and poured out into a collection container.

TABLE 5

| | Ingredients | Parts by Weight |
|---|---|---|
| Charge #1 | Ethyl Acetoacetate | 324.3 |
| Charge #2 | Ethyl Acetoacetate | 138.9 |
| | Trigonox 131 | 10.3 |
| Charge #3 | Butyl methacrylate | 1.01 |
| | Methyl methacrylate | 1.01 |
| | Styrene | 108.9 |
| | 2-Ethylhexyl acrylate | 317.5 |
| | A-174 | 75.62 |
| Charge #4 | Ethyl Acetoacetate | 12.4 |
| Charge #5 | Ethyl Acetoacetate | 12.4 |

The properties of the Polymers A-H are summarized in Table 6. The total free monomer was determined using gas chromatography. Mn and Mw were determined as previously described. Tg was calculated using the Fox Equation.

TABLE 6

| | Polymer I | Polymer J | Polymer K |
|---|---|---|---|
| Total free monomer (weight %) | 0.09 | 0.79 | 1.43 |
| Mw | 26228 | 30181 | 25697 |
| Mn | 4926 | 8606 | 8135 |
| PDI | 5.3 | 3.5 | 3.2 |
| Calculated Tg (° C.) | −25 | −25 | −16 |

The following table contains abbreviations or trade names of solvents, radical initiators, or acrylic monomer used in the examples:

TABLE 7

| Abbreviation or | | |
|---|---|---|
| Trade Name | Role | Chemical Name |
| TEP | Solvent | Triethyl phosphate |
| Trigonox 131 | Radical initiator | tert-Amylperoxy 2-ethylhexyl |
| | | carbonate |
| NVP | Monomer | N-Vinyl pyrrolidone |
| MMA | Monomer | Methyl methacrylate |
| EHA | Monomer | 2-Ethylhexyl acrylate |
| EA | Monomer | Ethyl acrylate |
| HEA | Monomer | 2-Hydroxyethyl acrylate |
| MAA | Monomer | Methacrylic acid |

### Synthesis of Resin L

In a four neck round bottom flask, 324.3 grams of triethyl phosphate (TEP) was added and the flask was set up with a mechanical stir blade, thermocouple, and reflux condenser. The flask containing TEP solvent was heated to a set point of 120° C. under a nitrogen atmosphere. A monomer solution containing 197.2 grams of MMA, 151.5 grams of EHA, 135.6 grams of EA, 9.9 grams of HEA, and 9.9 grams of MAA was thoroughly mixed. A solution of 10.3 grams of Trigonox 131 and 138.9 grams of TEP was prepared and added into the flask via an addition funnel over 360 minutes. Five minutes after the initiator solution started, the monomer solution was added into flask via an addition funnel over 300 minutes. After the monomer feed was complete, the monomer addition funnel was rinsed with 12.4 grams of TEP. After the initiator feed was complete, the initiator addition funnel was rinsed with 12.4 grams of TEP. The reaction was then held at 120° C. for 60 minutes. After the 60-minute hold, the reaction was cooled and poured into a suitable container. The final measured solids of the resin was determined to be 51.0% solids.

The solids content of the resin was measured in each resin example by the following procedure: An aluminum weighing dish from Fisher Scientific, was weighed using an analytical balance. The weight of the empty dish was recorded to four decimal places. Approximately 0.5 g of resin composition was added to the weighed dish and the weight of the dish and the acrylic resin solution was recorded to four decimal places. Next approximately 3.5 g of acetone was added to the weighing dish. The dish containing the acrylic resin solution and acetone was placed into a laboratory oven, with the oven temperature set to 110 degrees centigrade, and dried for 1 hour. The dish and dried acrylic resin were weighed using an analytical balance. The weight of the dish and dried acrylic resin was recorded to four decimal places. The solids content was determined using the following equation: % solids=100×[(weight of the dish and the dry acrylic resin)−(weight of the empty dish)]/[(weight of the dish and the acrylic resin solution)−(weight of the empty dish)].

### Synthesis of Resin M

In a four neck round bottom flask, 324.3 grams of triethyl phosphate (TEP) was added and the flask was set up with a mechanical stir blade, thermocouple, and reflux condenser. The flask containing TEP solvent was heated to a set point of 125° C. under a nitrogen atmosphere. A monomer solution containing 197.1 grams of MMA, 186.3 grams of EHA, 50.4 grams of EA. 50.4 grams of NVP. 9.9 grams of HEA, and 9.9 grams of MAA was thoroughly mixed. A solution of 10.3 grams of Trigonox 131 and 138.9 grams of TEP was prepared and added into the flask via an addition funnel over 360 minutes. Five minutes after the initiator solution started, the monomer solution was added into flask via an addition funnel over 300 minutes. After the monomer feed was complete, the monomer addition funnel was rinsed with 12.4 grams of TEP. After the initiator feed was complete, the initiator addition funnel was rinsed with 12.4 grams of TEP. The reaction was then held at 125° C. for 60 minutes. After the 60-minute hold, the reaction was cooled and poured into a suitable container. The final measured solids of the resin was determined to be 51.0% solids.

### Preparation of Binder Compositions

Chemical suppliers: PVDF was obtained from Shanghai 3F (T-1 PVDF, “PVDF 1”) and Solvay (PVDF Solef 5130, “PVDF 2”). Tricthylphosphate (“TEP”) and ethyl acetoacetate (“EAA”) are both available from the Eastman Chemical Company. Resimene HM-2608 (90% active material in isobutanol) was obtained from INEOS. A 10% active material solution of Resimene HM-2608 was prepared in TEP (“additive solution Z”).

### Preparation of PDVF Dispersion-Binder P1

A dispersion of PVDF was prepared in a mixture of TEP and EAA (TEP:EAA=80:20 by weight) by the addition of Resin L, Resin M and PVDF 1 on a 500 gram scale. A total of 66.5 g of acrylic resins and 190.1 grams of PVDF were used to make the binder dispersion, “P1”. The weight ratio of acrylic resins was 2.0 parts resin A to 1.0 part resin B. “P1” has a calculated total solids (by weight) of 45.0%.

### Preparation of PDVF Solution-Binder P2-1

A PVDF solution was prepared by dissolving silane-functional addition polymers and PVDF 2 in TEP under high shear mixing using a Cowles blade on a 192-gram scale according to the following procedure. 9.66 grams of PVDF were added to 181.28 grams of TEP and agitated until dissolved. 1.65 grams of silane-functional addition Polymer J (78% solids in TEP) were added and agitated. The weight ratios of silane-functional addition polymers to PVDF were 11.76 parts resin to 88.24 parts PVDF. Binder P2-1 had a total solids of 5.69% (by weight).

### Preparation of PDVF Solution-Binder P2-2

A PVDF solution was prepared by dissolving silane-functional addition polymers and PVDF 2 in TEP under high shear mixing using a Cowles blade on a 692-gram scale according to the following procedure. 34.16 grams of PVDF were added to 645 grams of TEP and agitated until dissolved. 12.88 grams of silane-functional addition Polymer J (78% solids in TEP) were added and agitated. The weight ratio of silane-functional addition polymers to PVDF was 22.7 parts resin to 77.3 parts PVDF. Binder P2-2 had a total solids of 6.39% (by weight).

### Preparation of PDVF Solution-Binder P2/No Silane

A PVDF solution was prepared by dissolving PVDF 2 in TEP under high shear mixing using a Cowles blade on a 100-gram scale according to the following procedure. A total of 5.1 grams of PVDF were dissolved in 94.9 grams of TEP to prepare binder “P2/no silane”. Binder P2/no silane had a total solids of 5.1% (by weight).

### Preparation of Slurry Compositions

Method 1: In a nitrogen filled glove bag, the binder solution was diluted with TEP or a mixture of TEP/EAA and added to a Thinky cup. Conductive carbon was added and mixed with a wooden blade by hand. The Thinky cup was capped and removed from the glove bag. Dispersion of the carbon was achieved using a centrifugal mixer. Once homogenous, the carbon slurry was returned to the glove bag, uncapped, and the active material was added. The active material/carbon slurry was mixed by hand using a wooden blade, capped, and removed from the glove bag. Dispersion of the active material was achieved using a centrifugal mixer. Once homogenous, the carbon/active material slurry was returned to the glove bag, uncapped, and the additive solution was added. The fully formulated cathode slurry was mixed by hand using a wooden blade, capped, and removed from the glove bag. Final dispersion of all of the cathode slurry components was completed using a centrifugal mixer.

### Example 1

### Preparation of Experimental Slurry Composition (S1):

This slurry was prepared on a 100-gram scale with a weight ratio of 96% active material to 2% conductive carbon to 2% binder. Table 8 provides the exact weights of the components used in the preparation of slurries according to Method 1. The weight % solids of the slurry was 75.6%.

TABLE 8

| Component | Role | Amount (grams) |
|---|---|---|
| NCM811 | Active Material | 72.576 |
| LitX 200 | Conductive Carbon | 1.512 |
| Binder P1 | Binder | 0.834 |
| Binder P2-1 | Binder | 19.946 |
| TEP | Diluent | 4.762 |
| EAA | Diluent | 1.129 |
| Additive Solution Z | Additive | 0.192 |

Preparation of Comparative NMP Slurry Composition (S2): Slurry compositions were prepared on a 100-gram scale with a weight ratio of 96% active material to 2% conductive carbon to 2% binder. The slurry was prepared at room temperature)(23° C. with a humidity of 0-35% (in a dry bag). First, the binder (PVDF) was dissolved in the diluent (NMP) in a Thinky cup. Next conductive carbon was added and mixed with a wooden blade by hand. Dispersion of the carbon was achieved using a centrifugal mixer. Once homogenous, the active material was then added. The active material/carbon slurry was mixed by hand using a wooden blade. Dispersion of the active material was completed using a centrifugal mixer.

Table 9 provides the exact weights of the components used in the preparation of NMP slurry. The weight % solids of the slurry was 66%.

TABLE 9

| Component | Role | Amount (grams) |
|---|---|---|
| NCM811 | Active Material | 63.36 |
| LitX 200 | Conductive Carbon | 1.32 |
| PVDF | Binder | 1.32 |
| NMP | Diluent | 34.00 |

Preparation of Comparative Slurry Composition that does not Include a Silane-Functional Addition Polymer (S3):

This slurry was prepared on a 50-gram scale with a weight ratio of 96% active material to 2% conductive carbon to 2% binder. Table 10 provides the exact weights of the components used in the preparation of slurries according to method 1. The weight % solids of the slurry was 74%.

TABLE 10

| Component | Role | Amount (grams) |
|---|---|---|
| NCM811 | Active Material | 35.52 |
| LitX 200 | Conductive Carbon | 0.74 |
| Binder P1 | Binder | 0.408 |
| Binder P2/no silane | Binder | 10.882 |
| TEP | Diluent | 1.844 |
| EAA | Diluent | 0.605 |
| Additive Solution Z | Additive | 0.105 |

### Preparation of Electrodes:

Electrode films were prepared using an 8 mil or 10 mil draw down bar on a draw down table onto aluminum foil. The deposited films were oven-dried for two minutes at 55° C. then for four minutes at 120° C. Each film was pressed using a calendar press to a porosity of 30% resulting in a film thickness ranging from 82 to 88 microns. The coating weight of the deposited cathode was 20.0-22.0 mg/cm².

### Evaluation of Electrode Adhesion:

Strips of coated electrode were cut 0.5 inches and affixed to an untreated aluminum panel using 3M 444 double sided tape. The adhesive strength of two strips of coated electrode were evaluated using a 90-degree peel test on MARK-10 ESM303 at a speed of 50 mm/min. This test is referred to herein as the PEEL STRENGTH TEST. The average peel strength was 26.7 N/m for the cathode from the slurry with silane-functional resin (S1) compared to 25.0 N/m for the cathode from NMP slurry (S2) and 17.1 N/m for the cathode from the slurry containing no silane-functional resin (S3). This demonstrated that the silane-functional acrylic polymer is able to improve the peel strength of cathodes at high loadings.

### Evaluation of Electrodes in Half Cell Coin Cells:

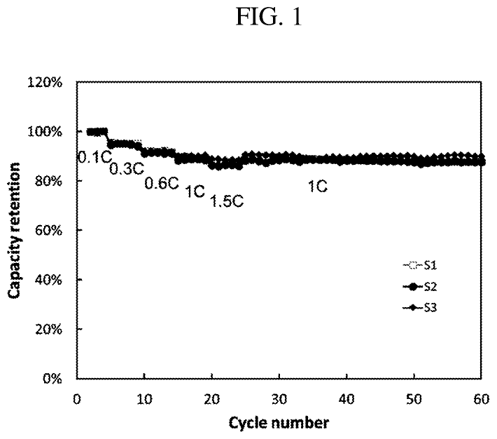

Electrodes were tested in half cell coin cells. The prepared electrodes were cut into a disk with 10 mm in diameter. Li metal was used as the counter electrode and the electrolyte was 1.0 M LiPF₆ in EC/EMC (3:7, v:v). The cells were tested at 0.1 C for 3 cycles, 0.3 C, 0.6 C, 1.0 C and 1.5 C for 5 cycles, respectively, and 1.0 C for long term cycling. FIG. 1 shows the cycling performance of the electrodes prepared from different slurries. It can be observed that there is no significant difference among the electrodes prepared from S1, S2 and S3, indicating that silane-functional addition polymers have no detrimental effect on the electrochemical performance in lithium ion batteries.

### Example 2

### Preparation of Experimental Slurry Composition (S4):

This slurry, S4, was prepared on a 50-gram scale with a weight ratio of 96% active material to 2% conductive carbon to 2% binder. Table 11 provides the exact weights of the components used in the preparation of slurries according to Method 1. The weight % solids of the slurry was 73.3%.

TABLE 11

| Component | Role | Amount (grams) |
|---|---|---|
| NCM811 | Active Material | 35.184 |
| LitX 200 | Conductive Carbon | 0.733 |
| Binder P2-1 | Binder | 12.89 |
| TEP | Diluent | 1.19 |

### Preparation of Experimental Slurry Composition (S5):

This slurry, S5, was prepared on a 50-gram scale with a weight ratio of 96% active material to 2% conductive carbon to 2% binder. Table 12 provides the exact weights of the components used in the preparation of slurries according to Method 1. The weight % solids of the slurry was 73%.

TABLE 12

| Component | Role | Amount (grams) |
|---|---|---|
| NCM811 | Active Material | 35.04 |
| LitX 200 | Conductive Carbon | 0.73 |
| Binder P2-2 | Binder | 11.624 |
| TEP | Diluent | 2.606 |

Preparation of Comparative Slurry Composition that does not Include a Silane-Functional Addition Polymer (S6):

This slurry, S6, was prepared on a 50-gram scale with a weight ratio of 96% active material to 2% conductive carbon to 2% binder. Table 13 provides the exact weights of the components used in the preparation of slurries according to Method 1. The weight % solids of the slurry was 68.8%.

TABLE 13

| Component | Role | Amount (grams) |
|---|---|---|
| NCM811 | Active Material | 33.024 |
| LitX 200 | Conductive Carbon | 0.688 |
| Binder P2/no silane | Binder | 13.490 |
| TEP | Diluent | 2.798 |

### Preparation of Electrodes:

Electrode films were prepared using an 8 mil or 10 mil draw down bar on a draw down table onto aluminum foil. The deposited films were oven-dried for two minutes at 55° C. then for four minutes at 120° C. Each film was pressed using a calendar press to a porosity of 30% resulting in a film thickness ranging from 82 to 88 microns. The coating weight of the deposited cathode was 20.0-22.0 mg/cm².

### Evaluation of Electrode Adhesion:

Strips of coated electrode were cut 0.5 inches and affixed to an untreated aluminum panel using 3M 444 double sided tape. The adhesive strength of two strips of coated electrode were evaluated using a 90-degree peel test on MARK-10 ESM303 at a speed of 50 mm/min. This test is referred to herein as the PEEL STRENGTH TEST. The average peel strength was 32.3 N/m for the cathode from the slurry S4, 30.7 N/m for the cathode from S5 and 25.6 N/m for S6. The peel strength from the slurries containing silane-functional addition polymers (S4 and S5) was much higher than that obtained from the slurry without silane-functional resin (S6). This demonstrated that the silane-functional acrylic polymer is effective to enhance the adhesion/cohesion of cathodes.

It will be appreciated by skilled artisans that numerous modifications and variations are possible in light of the above disclosure without departing from the broad inventive concepts described and exemplified herein. Accordingly, it is therefore to be understood that the foregoing disclosure is merely illustrative of various exemplary aspects of this application and that numerous modifications and variations can be readily made by skilled artisans which are within the spirit and scope of this application and the accompanying claims.

1. A slurry composition comprising:
an electrochemically active material and/or an electrically conductive agent;
a fluoropolymer;
an addition polymer comprising a silicon-containing functional group comprising at least one alkoxy substituent; and
a liquid medium.

2. The slurry composition of claim 1, wherein the liquid medium comprises an aqueous medium.

3. The slurry composition of claim 1, wherein the liquid medium comprises an organic medium comprising an organic solvent.

4-5. (canceled)

6. The slurry composition of claim 1, wherein the addition polymer has a silicon-containing functional group equivalent weight of 500 g/eq to 50,000 g/eq.

7. The slurry composition of claim 1, wherein the addition polymer has an alkoxy equivalent weight of 75 g/eq to 15,000 g/eq.

8. The slurry composition of claim 1, wherein the addition polymer comprises the residue of:
0.5% to 40% by weight of ethylenically unsaturated monomers comprising a silicon-containing functional group comprising at least one alkoxy substituent; and
60% to 99.5% by weight of ethylenically unsaturated monomers that do not include a silicon-containing functional group.

9. The slurry composition of claim 1, wherein the fluoropolymer is present in an amount of 20% to 99.9% by weight; and the addition polymer comprising a silicon-containing functional group comprising at least one alkoxy substituent in present in an amount to of 0.1% to 25% by weight, based on the total weight of the binder solids.

10. The slurry composition of claim 1, wherein the addition polymer has a glass transition temperature of less than 100° C.

11. The slurry composition of claim 1, further comprising a crosslinking agent.

12. The slurry composition of claim 11, wherein the crosslinking agent is present in an amount of 0.1% to 25% by weight, based on the total weight of the binder solids.

13-14. (canceled)

15. The slurry composition of claim 1, wherein the fluoropolymer is dispersed in the liquid medium.

16. The slurry composition of claim 1, wherein the fluoropolymer is solubilized in the liquid medium.

17-20. (canceled)

21. The slurry composition of claim 1, further comprising a (meth)acrylic polymer.

22-23. (canceled)

24. The slurry composition of claim 1, further comprising a non-polymeric alkoxysilane compound.

25. (canceled)

26. A slurry composition comprising:
an electrochemically active material and/or an electrically conductive agent;
a fluoropolymer;
a non-polymeric alkoxysilane compound; and
a liquid medium.

27-41. (canceled)

42. An electrode comprising a current collector and a film on the surface of the current collector, the film comprising:
an electrochemically active material and/or an electrically conductive agent;
a fluoropolymer; and
an addition polymer comprising a silicon-containing functional group comprising at least one alkoxy substituent.

43. The electrode of claim 42, wherein the film has an adhesion to the current collector as measured by the PEEL STRENGTH TEST at least 10% higher than a comparative film that does not include the addition polymer comprising a silicon-containing functional group comprising at least one alkoxy substituent.

44. The electrode of claim 42, wherein the film is deposited from a slurry composition comprising:
an electrochemically active material and/or an electrically conductive agent;
a fluoropolymer;
an addition polymer comprising a silicon-containing functional group comprising at least one alkoxy substituent; and
a liquid medium.

45-50. (canceled)

51. An electrical storage device comprising: (a) the electrode of claim 42; (b) a counter electrode; and (c) an electrolyte.

52-80. (canceled)
